(19) United States
(12) Patent Application Publication
(10) Pub. No.: US 2025/0155787 A1
(43) Pub. Date: May 15, 2025

(54) ZONE ILLUMINATED REFLECTIVE DISPLAY

(71) Applicant: Meta Platforms Technologies, LLC, Menlo Park, CA (US)

(72) Inventors: Fenglin Peng, Redmond, WA (US); Jacques Gollier, JR., Sammamish, WA (US); Yung-Yu Hsu, San Jose, CA (US); Robert Upton, Del Mar, CA (US); Thomas Charisoulis, San Carlos, CA (US); Yun Wang, Bellevue, WA (US); Brendan Hamel-Bissell, Federal Way, WA (US); Zhaoning Yu, Lynnwood, WA (US); Joshua Cobb, Victor, NY (US); Brandon Michael Hellman Friedman, Redmond, WA (US); Anurag Tyagi, Mill Creek, WA (US); John DeFranco, San Carlos, CA (US); Xin Tong, Alhambra, CA (US)

(21) Appl. No.: 18/922,725

(22) Filed: Oct. 22, 2024

Related U.S. Application Data
(60) Provisional application No. 63/598,386, filed on Nov. 13, 2023.
(60) Provisional application No. 63/606,836, filed on Dec. 6, 2023.

(51) Int. Cl. G03B 21/20; G03B 21/28

(52) U.S. Cl. CPC G03B 21/2013; G03B 21/208; G03B 21/28

(57) ABSTRACT

An illumination system includes a micro-LED array having a plurality of individually addressable diodes, a concentrator array overlying an output of the micro-LED array and configured to decrease a numerical aperture of light emitted by the array, and a non-emissive display panel arranged to receive light from the concentrator array.

### CROSS-REFERENCE TO RELATED APPLICATIONS

This application claims the benefit of priority under 35 U.S.C. § 119(e) of U.S. Provisional Application No. 63/598,386, filed Nov. 13, 2023, and U.S. Provisional Application No. 63/606,836, filed Dec. 6, 2023, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is an illustration of a triple pass zonal illumination system according to some embodiments.

FIG. 2 is an illustration of a triple pass zonal illumination system according to further embodiments.

FIG. 3 is an illustration of a double pass zonal illumination system according to some embodiments.

FIG. 4 illustrates an example device for non-emissive displays with zonal illumination according to some embodiments.

FIG. 5 illustrates an example system for non-emissive displays with zonal illumination according to certain embodiments.

FIG. 6 illustrates an example system for non-emissive displays with zonal illumination according to further embodiments.

FIG. 7 illustrates an example system for non-emissive displays with zonal illumination according to further embodiments.

FIG. 8 illustrates an example three-panel case for illuminating non-emissive displays with zonal illumination according to some embodiments.

FIG. 9 illustrates an example system for non-emissive displays with zonal illumination according to some embodiments.

FIG. 10 illustrates an example system for non-emissive displays with zonal illumination according to further embodiments.

FIG. 11 illustrates an example system for non-emissive displays with zonal illumination according to still further embodiments.

FIG. 12 illustrates an example system for non-emissive displays with zonal illumination according to certain embodiments.

FIG. 13 shows an LED array and a taper design for a zonal illumination system together with associated performance data according to various embodiments.

FIG. 14 illustrates example collection optics devices for use in non-emissive displays with zonal illumination according to some embodiments.

FIG. 15 shows exemplary taper array and CPC array architectures according to certain embodiments.

FIG. 16 shows the co-integration of a taper array with a micro-LED array according to some embodiments.

FIG. 17 is a schematic comparison of the operation of global and zonal illumination systems according to some embodiments.

FIG. 18 shows an example circuit design for an integrated backlight unit (BLU) driver according to certain embodiments.

FIG. 19 is an illustration of an example artificial-reality system according to some embodiments of this disclosure.

FIG. 20 is an illustration of an example artificial-reality system with a handheld device according to some embodiments of this disclosure.

FIG. 21A is an illustration of example user interactions within an artificial-reality system according to some embodiments of this disclosure.

FIG. 21B is an illustration of example user interactions within an artificial-reality system according to some embodiments of this disclosure.

FIG. 22A is an illustration of example user interactions within an artificial-reality system according to some embodiments of this disclosure.

FIG. 22B is an illustration of example user interactions within an artificial-reality system according to some embodiments of this disclosure.

FIG. 23 is an illustration of an example wrist-wearable device of an artificial-reality system according to some embodiments of this disclosure.

FIG. 24 is an illustration of an example wearable artificial-reality system according to some embodiments of this disclosure.

FIG. 25 is an illustration of an example augmented-reality system according to some embodiments of this disclosure.

FIG. 26A is an illustration of an example virtual-reality system according to some embodiments of this disclosure.

FIG. 26B is an illustration of another perspective of the virtual-reality system shown in FIG. 26A according to some embodiments.

FIG. 27 is a block diagram showing system components of example artificial- and virtual-reality systems according to some embodiments.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Virtual reality (VR) and augmented reality (AR) eyewear devices and headsets enable users to experience events, such as interactions with people in a computer-generated simulation of a three-dimensional world or viewing data superimposed on a real-world view. Superimposing information onto a field of view may be achieved through an optical head-mounted display (OHMD) or by using embedded wireless glasses with a transparent heads-up display (HUD) or augmented reality overlay. VR/AR eyewear devices and headsets may be used for a variety of purposes. Governments may use such devices for military training, medical professionals may use such devices to simulate surgery, and engineers may use such devices as design visualization aids.

Virtual reality and augmented reality devices and headsets typically include an optical system having a microdisplay and imaging optics. Display light may be generated and projected to the eyes of a user using a display system where the light is in-coupled into a waveguide, transported therethrough by total internal reflection (TIR), replicated to form an expanded field of view, and out-coupled when reaching the position of a viewer's eye.

The microdisplay may be configured to provide an image to be viewed either directly or indirectly using, for example, a micro-OLED display or by illuminating a liquid-crystal based display such as a liquid crystal on silicon (LCoS) microdisplay. Liquid crystal on silicon is a miniaturized reflective or transmissive active-matrix display having a liquid crystal layer disposed over a silicon backplane. During operation, light from a light source is directed at the liquid crystal layer and as the local orientation of the liquid crystals is modulated by a pixel-specific applied voltage, the phase retardation of the incident wavefront can be controlled to generate an image from the reflected or transmitted light. In some instantiations, a liquid crystal on silicon display may be referred to as a spatial light modulator.

LCoS-based projectors typically use three LCoS chips, one each to modulate light in the red, green, and blue channels. An LCoS projector may be configured to deliver the red, green, and blue components of image light simultaneously, which may result in a projected image having rich and well-saturated colors. As will be appreciated, an LCoS display may be configured for wavelength selective switching, structured illumination, optical pulse shaping, in addition to near-eye displays.

Due at least in part to inherent high resolution and high fill factors (minimal inter-pixel spacing), visible pixelation on an LCoS machine may be essentially nonexistent resulting in a high fidelity, continuous image. Moreover, in contrast to micro-mirror based projection systems that can generate high frequencies that accentuate their digital nature, LCoS pixel edges tend to be smoother, which may give them an analog-like response resulting in a more natural image.

Notwithstanding recent developments, a challenge facing LCoS technology is the generation of adequate contrast, e.g., on/off contrast. Most LCoS systems are rated in the range of 500:1 to 800:1, which is markedly less than the contrast performance available with alternative projector platforms. Furthermore, LCoS projectors tend to have limited lamp life. In view of the foregoing, it would be advantageous to provide an LCoS projector system with improved image contrast, extended lamp life, and reduced power consumption in a commercially-relevant form factor.

LCoS projection systems utilize a group of optical sources whose light is conditioned by illumination optics in space and angle to provide a uniform illumination of the LCoS panel, whilst delivering an angularly efficient beam to the viewing pupil of the projector. Typical LCoS systems provide a simultaneous, non-addressable, and global illumination of the LCoS panel that delivers a consistent and uniform amount of flux regardless of the RGB color content and sparsity of the image to be projected. These systems tend to be power inefficient, possess thermal management problems from the optical sources, and have poor sequential contrast.

As disclosed herein, the foregoing challenges may be overcome by the illumination of specific zones of the LCoS panel using addressable sources, concentrator optics, and catadioptric illumination imaging optics to deliver RGB light to the LCoS panel. The operation of a zonal illumination system makes use of an array of optical concentrators whose properties are designed to improved the spatial uniformity, RGB color mixing, and the far-field angular distribution for maximum optical etendue efficiency.

Non-emissive displays, such as Liquid Crystal on Silicon (LCoS) and Digital Light Processing (DLP) devices, may operate in tandem with an external light source functioning as an illuminator to emit light indirectly. For example, the illuminator may illuminate the non-emissive display, which may in turn modulate the light from the illuminator to produce the image. Due to the operating principles of the non-emissive display and/or due to imperfections in the non-emissive display, not all of the light from the illuminator may be used to form the image. Some of the light may be absorbed and/or scattered by the display.

As will be appreciated, non-image light may result in wasted power, which may not only impact overall power consumption, but also, in various contexts (such as an augmented reality or virtual reality display), impact other factors such as shortened battery life and the generation of unwanted waste heat. In addition, some non-image light may return to the user's vision, thereby reducing the effective contrast ratio of the display.

The devices and systems described herein may improve both the power efficiency and the contrast ratio of non-emissive displays by using zonal illumination. For example, some image content, such as augmented reality image content, may be sparse (e.g., such that only a relatively small area of the entire display is illuminated). Fully illuminating the entirety of such a display may waste a large amount of power. The devices and systems described herein may be configured to illuminate only a portion of the area of the display, thus decreasing power consumption.

In addition, some non-emissive displays may have a limited contrast ratio. For example, the polarization methods used by LCoS displays may achieve a contrast ratio of less than 1000:1. Thus, in the context of an augmented reality display, areas of the display that should be transparent according to the image may instead show large gray artifacts. The devices and systems described herein may illuminate only a portion of the area of the display (dependent, e.g., on the content of the image), reducing or eliminating such artifacts.

By using two modulation panels, a source array and a display panel, exemplary systems and devices may provide a pixelated illumination source, individually controlling the brightness (and, in some examples, color) of each zone of illumination at the display and reducing power that would otherwise been expended on zones with low image brightness. In some examples, the non-emissive display array may maintain a high bit depth—e.g., using a high-resolution display panel with a lower resolution source array. In addition, these systems and devices may control the duration for each color inside each zone individually. These systems and devices may control each zone's color duty ratio to achieve, e.g., higher wall plug efficiency and fewer color breakups.

In some examples, a display system may include a non-emissive display. The non-emissive display may be pixelated. In some examples, the non-emissive display may operate by reflecting, in a modulated form, light from an illumination device. The display system may also include a collimating optics device that collimates light from the pixelated display with a given collection angle. The display system may also include the illumination device. In some examples, the illumination area of the illumination device may be divided into smaller areas within which irradiance and color may be individually adjustable. The display system may also include an illumination optical device that images the emission area of the illumination device onto the non-emissive display such that the emission area is magnified onto the display area and the magnified illumination cone is as large or larger than the collimating collection cone of the collimating optics device.

An illumination device may include an illumination source. In some examples, the illumination source may include an array of illumination components. For example, the illumination source may include a mini light-emitting diode (LED) array, a micro-LED array, and/or a laser array. In some examples, the illumination device may include a collection optics element in front of the illumination source array that re-forms the illumination angle and/or mixes red, green, and blue (RGB) colors. Examples of the collection optics element includes, without limitation, a micro lens array, a straight integrating bar, a tapered integrating bar, and a compound parabolic collector (CPC) array.

In some examples, the illumination source array may provide source light for multiple colors (e.g., RGB) on the same panel. Additionally, or alternatively, the illumination source array may include multiple separate panels with different source colors. In this example, the colors from separate panels may be combined using a color combiner. Examples of the color combiner may include a wedge combiner, a dichroic prism, a polarizing beam splitter (PBS) cube, and/or an X-cube. In some examples, the illumination source array may produce different colors by using an individual RGB device (e.g., an RGB LED device) or by using a color conversion layer (e.g., a blue or ultraviolet LED pump along with RGB quantum dots and/or phosphors to produce different colors from the blue/ultraviolet light). In some examples, a collection optics element located adjacent to the illumination source array may be configured to change the emission cone and area of the illumination source array.

In some examples, the display system may include one or more reflective mirrors or polarizers (e.g., mirror or polarization films) that provide polarization recovery, thereby achieving higher efficiency.

In some examples, the display system may include one or more additional elements to relay the image signal from the illuminator. Examples include, without limitation, one or more refractive lenses (including, e.g., a refractive lens with polarization folding and/or a PBS cube), one or more diffractive lenses, a waveguide (e.g., with one or more refractive and/or diffractive lenses), and/or laser scanning illumination.

In some examples, as mentioned above, the non-emissive display may be an LCoS display or a DLP display. In some examples, the non-emissive display may be another type of non-emissive display, such as a liquid crystal display (LCD).

In some examples, one or more polarization elements (e.g., polarization films) may be placed in line with and/or coupled to the non-emissive display. For example, a C-plate (or functionally equivalent) film may be coupled the non-emissive display to provide compensation for an improved contrast ratio.

In some examples, the display system may implement projection optics using refractive lenses along with polarization folding, thereby converting imaging to be coupled into collimated light at different angles and then coupled into a waveguide. In some examples, one or more light paths of the display system may be folded with reflective mirrors and/or polarization folding (e.g., a PBS cube or pancake polarization folding), thereby potentially reducing the physical length and/or volume of the display system.

In an example method of operation, light is injected into the entrance apertures of a concentrator array where it undergoes spatial and angular conditioning before emerging from the exit apertures. The light from the exit apertures may be imaged by catadioptric optics to the surface of the LCoS panel. These optics may be configured to provide uniform spatial coverage and high optical etendue efficiency. Through the illumination optics there is now a nominal linear mapping between the light sources contained in individual concentrators and specific zones of the LCoS panel. Hence, the RGB color contributions and optical flux to different LCoS zones may be accomplished in a precise and controlled manner, which decreases optical power, increases the lifetime of the optical sources, improves the thermal management and image color, light content, contrast, and dynamic range of the projected images.

In some embodiments, a taper array (or other concentrator array) is located between the light source and the LCoS panel. The taper array is configured to condition the source light spatial and angular properties, which may improve collection efficiency and color mixing. In particular embodiments, the taper array may be arranged to provide a uniform distribution of light to the LCoS panel.

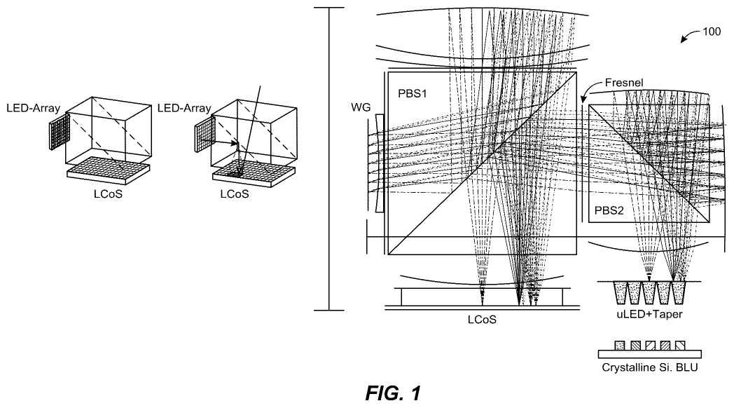

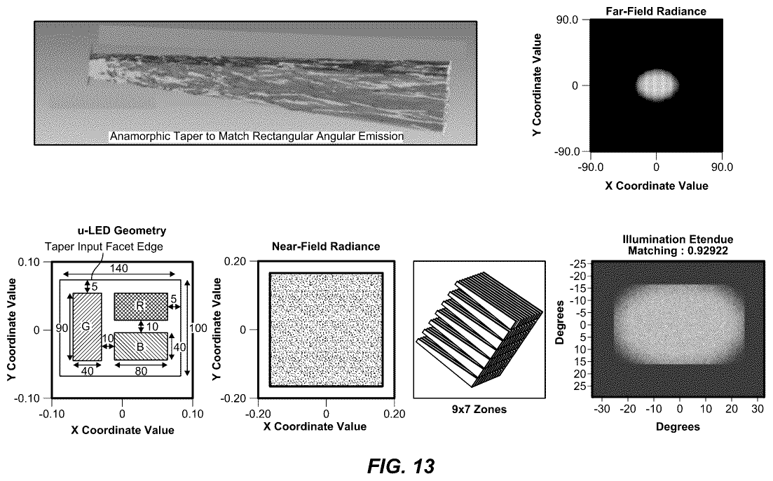

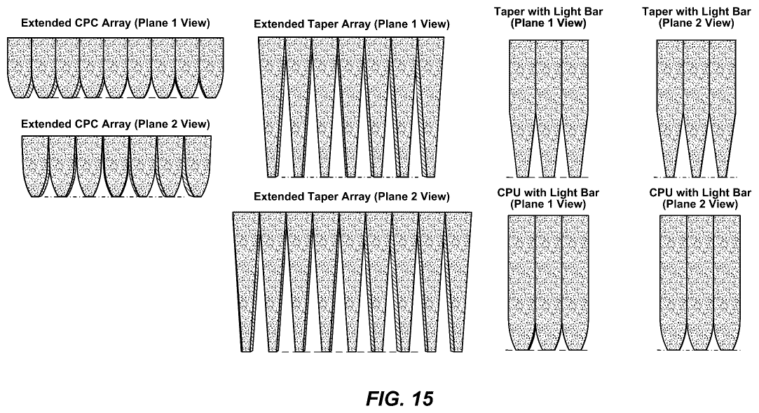

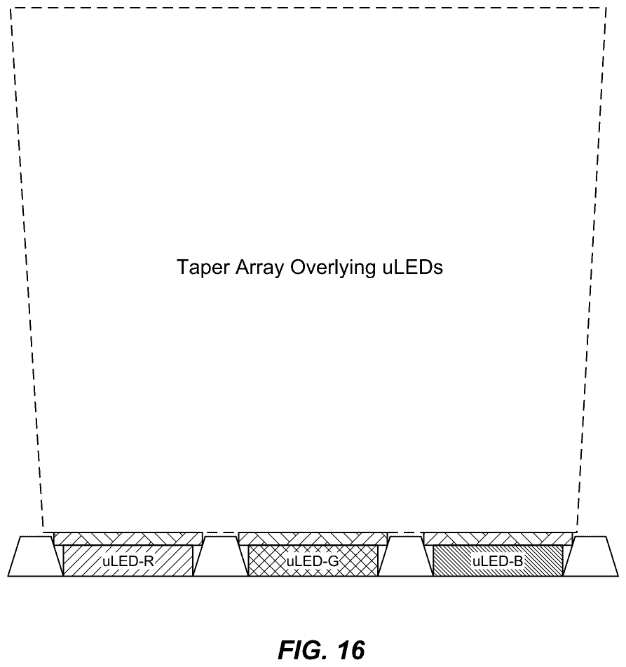

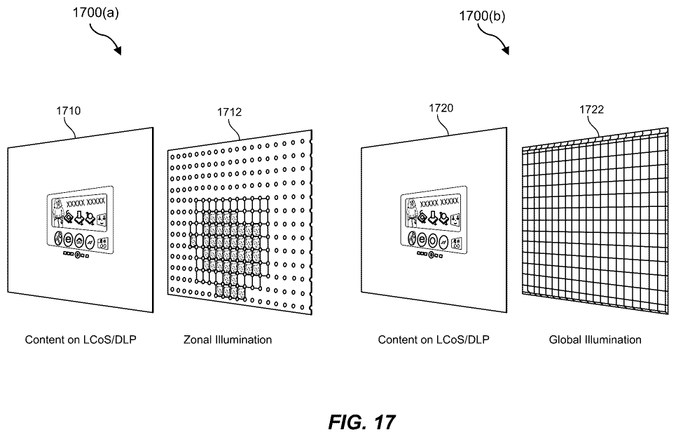

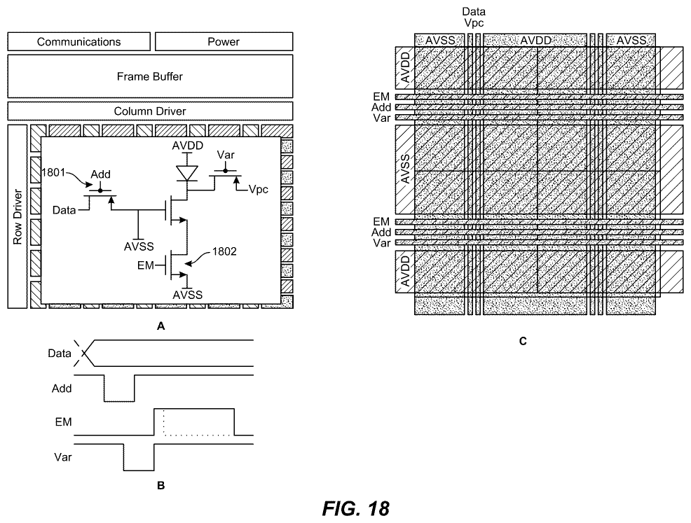

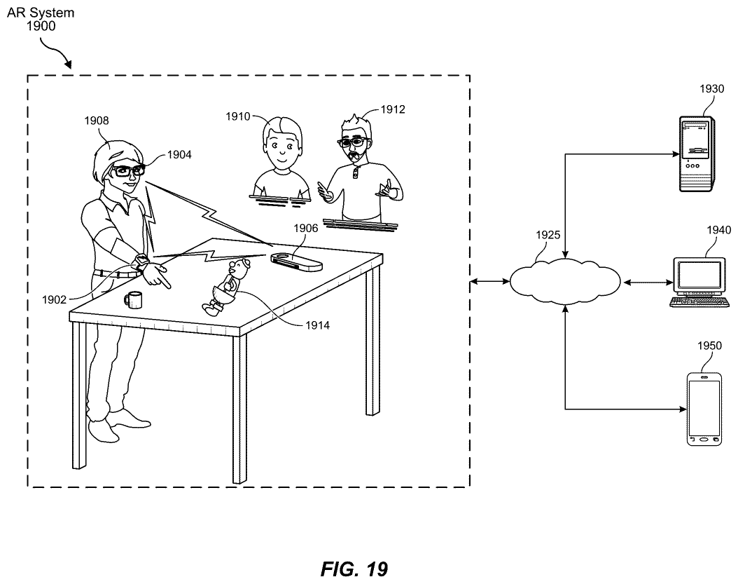

The following will provide, with reference to FIGS. 1-27, detailed descriptions of structures and related methods associated with the design, manufacture, and operation of a zone illuminated reflective display. The discussion associated with FIGS. 1-12 includes a description of exemplary zone illuminated reflective displays. The discussion associated with FIGS. 13-15 includes a description of a micro-LED geometry and concentrator array designs. The discussion associated with FIG. 16 includes a description of a light source for a zone illuminated reflective display, including a co-integrated taper array. The discussion associated with FIG. 17 includes a description of the principle of operation of a zone illuminated reflective display. The discussion associated with FIG. 18 includes a description of a circuit design for driving a light source for a zone illuminated reflective display. The discussion associated with FIGS. 19-27 relates to exemplary virtual reality and augmented reality devices that may include one or more zone illuminated reflective displays as disclosed herein.

In accordance with various embodiments, example designs of representative LCoS zonal illumination systems are shown in FIGS. 1-3, where systems 100, 200, 300 include a micro-LED array and optics to direct light from the LEDs onto an LCoS panel. The system optics may include, but are not restricted to, one or more polarizing beam splitters (PBS) and lenses such as converging or diverging lenses, including Fresnel lenses and catadioptric optics. The plural LEDs within the LED array may be individually addressed and configured to selectively and independently provide light output to a corresponding region of the LCoS panel.

In accordance with various embodiments, a concentrator array may be located within the output optical path of the micro-LED array. Given the nature of the emitted light, the LED array operates as a Lambertian source. The concentrator array may include a taper array or an array of compound parabolic concentrators (CPCs), for example, and may be configured to decrease the solid angle of emitted light. A CPC may be constructed as a combination of two symmetric parabolic segments having different focal lengths. The concentrator array may be designed to concentrate light emitted from the LED array for input to the systems optics and delivery to the LCoS plane. In particular embodiments, in a zone illuminated reflective display, a concentrator array may be configured to condition the spatial and angular distribution of light from the source such that a maximum efficiency of light incident on the LCoS panel may be achieved with targeted homogeneity and angular distribution.

The triple pass zone illumination system 100 of FIG. 1, for example, includes first and second polarization beam splitters (PBS1 and PBS2) and a Fresnel lens located therebetween. During operation, light emitted by an LED array may be configured to illuminate an LCoS. According to particular embodiments, various LEDs within the array may be controlled such that light generation and/or light output is synchronized with the creation of a target image. The LEDs contributing to dark or substantially unilluminated portions of a projected image may be unpowered, for example.

Referring still to FIG. 1, a concentrator array may be located downstream of the LED array, e.g., between the LED array and the first polarization beam splitter (PBS1). The concentrator array, which may include a plurality of tapered optical elements, may be configured to collect emitted light (i.e., light emitted from the LED array and characterized by a numerical aperture of approximately unity) and focus the emitted light into a bundle having a numerical aperture of less than 1, e.g., NA=0.3.

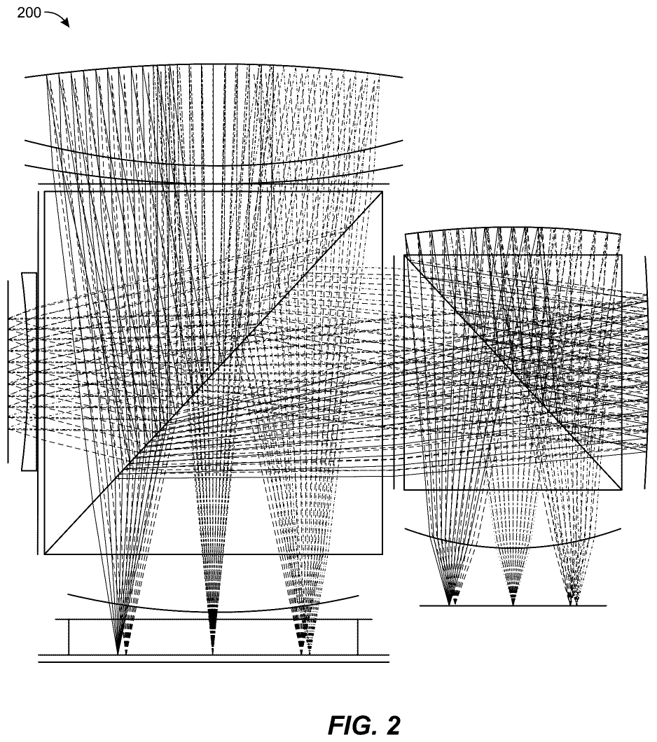

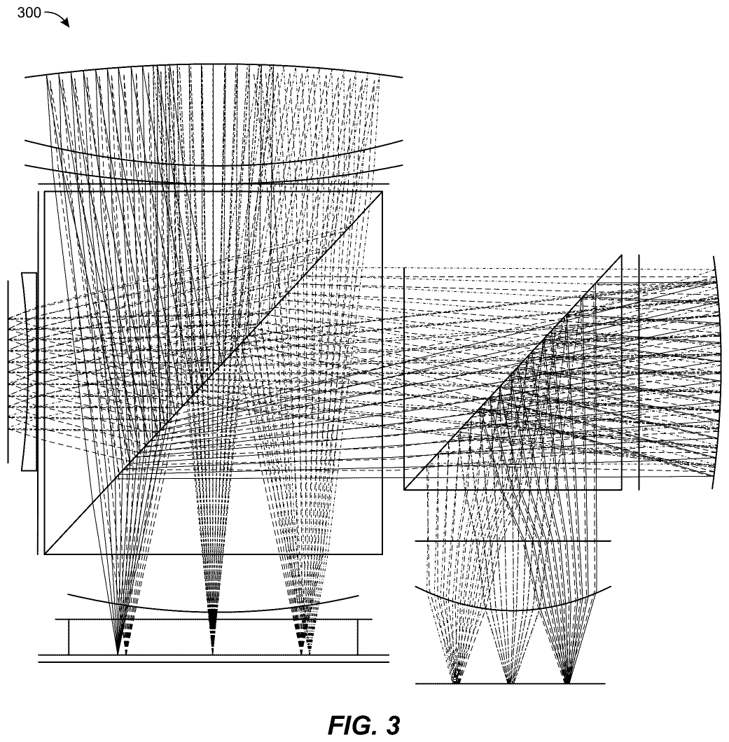

A pair of quarter waveplates, a single half waveplate, and a Fresnel lens are co-integrated into the triple pass illumination system 200 of FIG. 2, whereas the double pass illumination system 300 of FIG. 3 includes a single quarter waveplate and a single half waveplate. A Fresnel lens is omitted from the double pass illumination system 300.

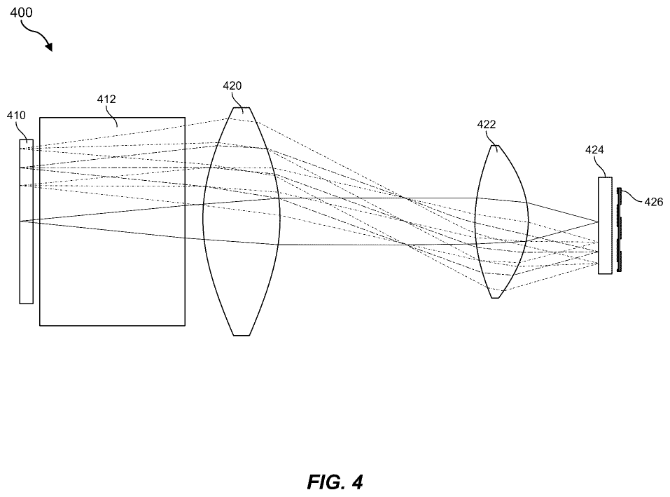

FIG. 4 illustrates an example device 400 for non-emissive displays with zonal illumination. As shown in FIG. 4, device 400 may include an LCoS 410, a PBS cube 412, a lens 420, a lens 422, a collection optics element 424, and an RGB mini-LED array 426 (with Lambertian emission characteristics).

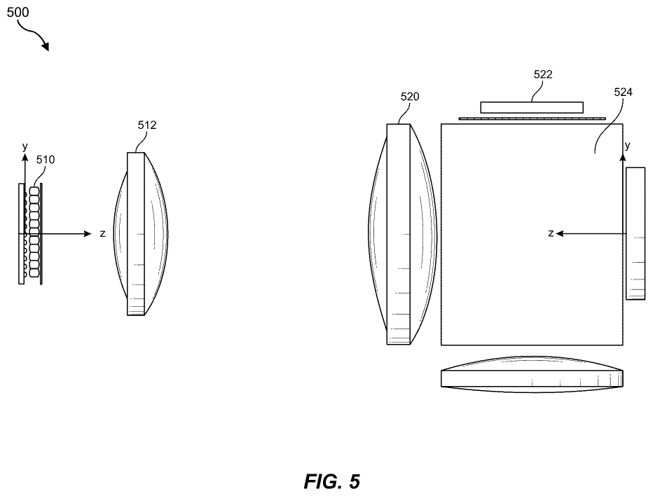

FIG. 5 illustrates an example system 500 for non-emissive displays with zonal illumination. In one example, system 500 may include a mini-LED with micro lens array 510. System 500 may also include one or more lenses, such as a lens 512 and a lens 520. System 500 may also include an LCoS display 522. System 500 may further include a PBS cube 524.

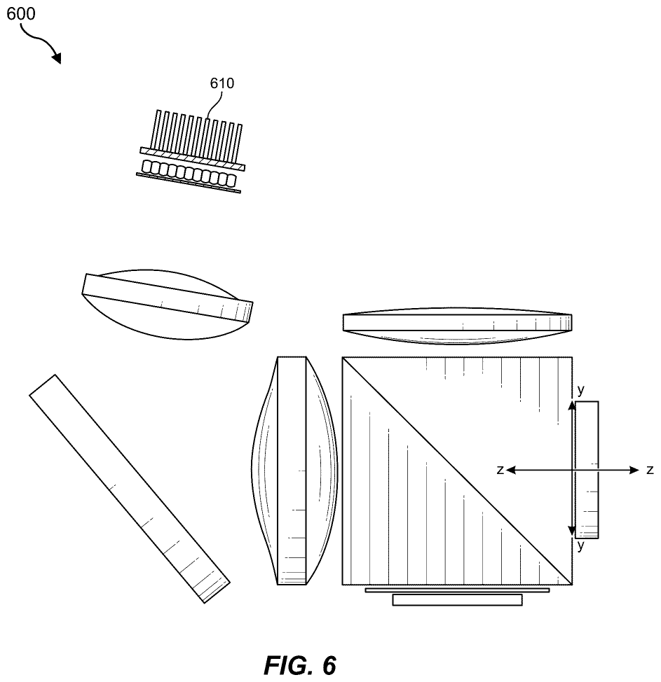

FIG. 6 illustrates an example system 600 for non-emissive displays with zonal illumination. As shown in FIG. 6, system 600 may include an LED array with an integrating bar array 610.

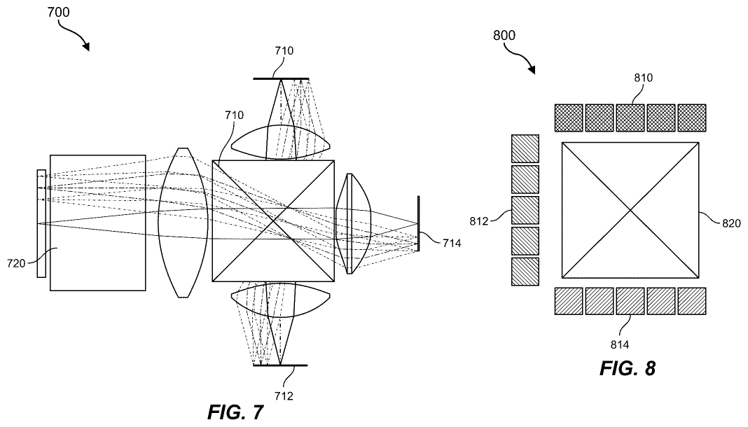

FIG. 7 illustrates an example system 700 for non-emissive displays with zonal illumination. As shown in FIG. 7, system 700 may include an LCoS display with PBS cube 720. System 700 may also include three source panels: a red LED array 710, a green LED array 712, and a blue LED array 714. The light emitted by the three source panels may be combined by an X-cube 730.

FIG. 8 illustrates an example three-panel case 800 for illuminating non-emissive displays with zonal illumination. As shown in FIG. 8, three-panel case 800 may include a red LED array 810, a blue LED array 812, a green LED array 814, and an X-cube 820.

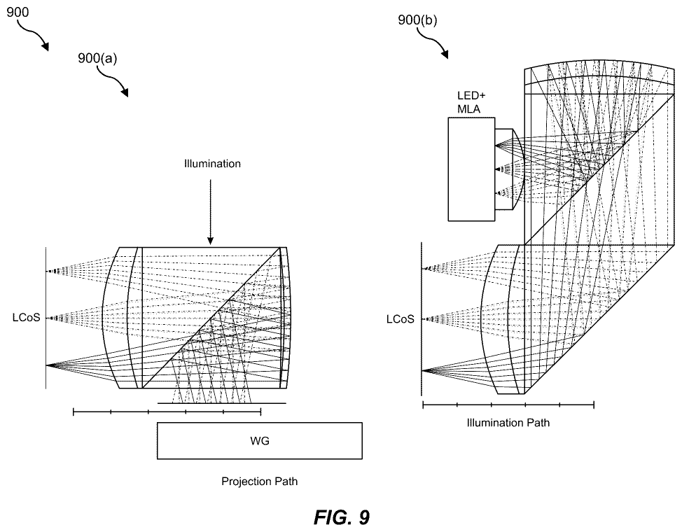

FIG. 9 illustrates an example system 900 for non-emissive displays with zonal illumination. A view 900(a) of shows a projection path of system 900. A view 900(b) shows an illumination path of system 900.

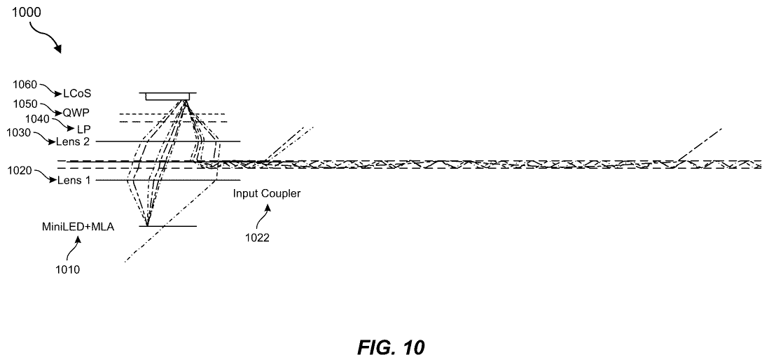

FIG. 10 illustrates an example system 1000 for non-emissive displays with zonal illumination. As shown in FIG. 10, system 1000 may include a mini-LED array with a micro lens array 1010, a lens 1020, a waveguide with an input coupler 1022, a lens 1030, a linear polarizer 1040, a quarter-wave plate 1050 (e.g., together with linear polarizer 1040, forming a circular polarizer), and an LCoS 1060.

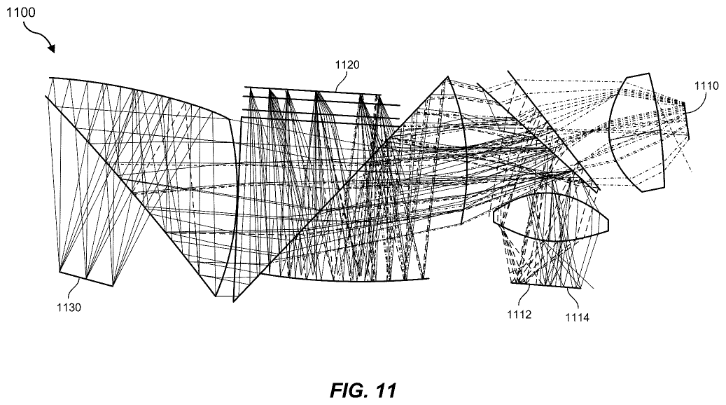

FIG. 11 illustrates an example system 1100 for non-emissive displays with zonal illumination. As shown in FIG. 11, system 1100 may include a green LED array 1110, a blue LED array 1112, a red LED array 1114, a digital micromirror device (DMD) 1120, and a pupil 1130. System 1100 may use a wedge combiner to combine the colors from the LED arrays.

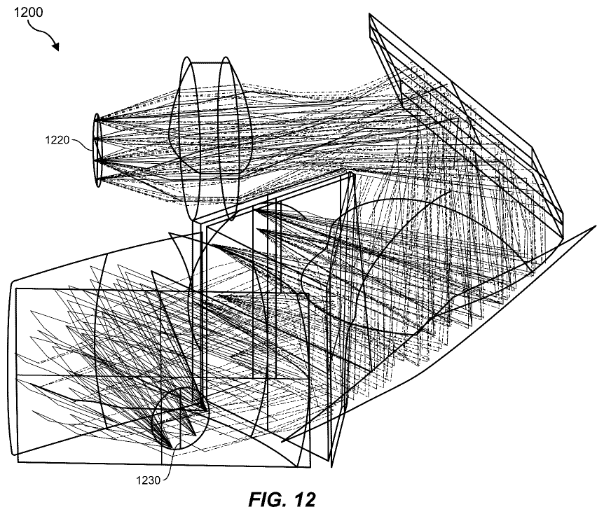

FIG. 12 illustrates an example system 1200 for non-emissive displays with zonal illumination. As shown in FIG. 12, system 1200 may include an LED array 1220 (RGB stripe) that illuminates a DLP panel (i.e., a digital micromirror device), the image from which arrives at a pupil 1230. System 1200 may include reflective-mirror-based folded light path.

Aspects of the micro-LED array and the concentrator array, including the impact of the latter on the near-field and far-field irradiance, are illustrated in FIG. 13. As will be appreciated, in addition to its impact on the solid angle of the emitted light, the concentrator array may beneficially provide effective color mixing of light produced by independent red, green, and blue emitters. In the configuration of FIG. 13, an anamorphic taper may be configured to align with a particular angular emission geometry.

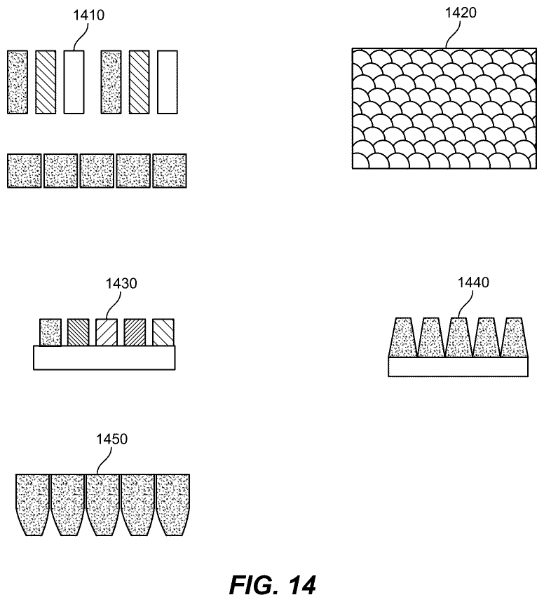

FIG. 14 illustrates example collection optics devices for use in non-emissive displays with zonal illumination. As shown in FIG. 14, a source illumination device may include a mini-LED array 1410. In some examples, a collection optics device used with array 1410 may include a micro lens array 1420. Additionally, or alternatively, a collection optics device used with array 1410 may include an integrating bar array 1430. In some examples, a collection optics device used with array 1410 may include a tapered bar array 1440. In some examples, a collection optics device used with array 1410 may include a CPC array 1450.

Example taper and CPC array architectures are illustrated in FIG. 15. Each concentrator within an array has an input and an output where the input area is less than the output area, which decreases the solid angle of emitted light from the taper according to the laws of light propagation. The input of an individual concentrator may be optically coupled with the output of a selected micro-LED or micro-LED sub-array, i.e., optically coupled with a trio of red, green, and blue emitters as shown in FIG. 13, where the input facet edge of an individual taper is shown superimposed on the LED geometry.

A concentrator array may be arranged to provide a uniform spatial and angular distribution of light to the LCoS panel. In particular embodiments, a CPC array may provide to the LCoS panel a precise rectangular or square angular distribution of light. Furthermore, although particular concentrator geometries are shown in FIG. 15, it will be appreciated that the present disclosure is not particularly limited and further concentrator geometries are contemplated.

Referring to FIG. 16, shown is a simplified schematic view of a taper array co-integrated with an array of LED emitters. The light emitted from the micro-LED sources is nominally Lambertian with light escaping from the lateral areas of the optical sources, which contributes to optical system loss and efficiency. In this embodiment, the micro-LED is integrated with reflective side structures that redirects light that otherwise escapes from the micro-LED back into the taper. In doing so the optical efficiency of the source may be increased.

FIG. 17 illustrates an example non-emissive display 1700(a) with zonal illumination and an example non-emissive display 1700(b) with global illumination. Display 1700(a) may include a zonal illumination source 1712 that provides uniform (e.g., spatially and/or temporally uniform) illumination onto a non-emissive display 1710. In contrast, display 1700(b) may include a global illumination source 1722 that provides differentiated illumination onto non-emissive display 1720. As will be appreciated, the output of each individual concentrator may be optically mapped to a plurality of pixels within the LCoS/DLP panel. For example, different zones of display 1720 may be illuminated with different amounts of light at different times, based on the brightness of the content in that zone. According to some embodiments, improved system efficiency and image contrast may be achieved where LEDs set to illuminate dark regions of an image simply remain off.

Disclosed also is driving circuitry for a zone illuminated reflective display. In this regard, Applicants note that backlight unit (BLU) drivers are typically designed to source high currents to large LEDs and are thus unsuitable for miniature BLUs. The BLU is time multiplexed and connected in a local passive matrix arrangement. This is due to the finite number of output pads that can be accommodated by the silicon drivers in low output systems. This limitation in the maximum pulse width may lead to increased currents, which results in the inefficient operation of BLU LEDs.

In some approaches, silicon micro-chiplets may be used to create active matrix displays utilizing silicon without multiplexing to achieve the required currents. Dicing and transfer processes may be used to arrange the micro-chiplets in a display configuration, albeit with considerable throughput and yield challenges. In further approaches, to avoid pad limitations, a driving system can be implemented on glass using thin film transistor (TFT) drivers. Achieving high output currents may be challenging, however, due to limited TFT mobility. High output current designs may include (a) a larger TFT size, which may undesirably increase the BLU pixel form factor, or (b) higher supply voltages, which may undesirably increase power consumption and operational inefficiency.

In view of the foregoing, disclosed are monolithically integrated BLU drivers, which may be implemented in a zone illuminated reflective display. The digital part of such a driver can operate in a low voltage domain (1.2 V) to maintain a low power draw while retaining the ability to drive large currents due to the large mobility of crystalline silicon, i.e., single crystal silicon. An example monolithically integrated BLU driver system is illustrated schematically in FIG. 8. In connection with various embodiments, the driver architecture is configured to provide power to selected diodes within a light source (e.g., micro-LED array) to the exclusion of non-selected diodes, thus sourcing light only to corresponding portions of the display.

In one example, a system may include a passive pixelated display with a given area, a collimating optics device that collimates light from the pixelated display with a given collection angle, an illumination device that has an emission area (e.g., different from the area of the passive pixelated display) and an emission cone of a given angle. The illumination area may be divided into a grid (e.g., n×m) of sub areas within which irradiance and color are individually adjustable. The system may also include an illumination optical device that images the emission area of the illumination device onto the pixelated display such that the emission area is magnified into the display area and the magnified illumination cone matches the collimating collection cone with the given collection angle.

Referring to FIG. 18 and initially to the block diagram of FIG. 18A, the system's pixel driver may be implemented with NMOS type transistors to allow for higher currents while maintaining low overhead voltages. In some embodiments, the driver may be configured as an 8-bit driver or a 10-bit driver. The exemplary circuit includes an address transistor 1801 that is configured to store data to AVSS, and a binary emission control transistor 1802 that may be configured to control the pulse width of LED emission. The data from address transistor 1801 may include driving current information, for example, which can determine the amplitude of light emission for a given LED. That is, a driving circuit may be configured to independently superimpose control of both the intensity of emission (i.e., brightness) as well as a binary state of emissive output (i.e., ON/OFF). A timing diagram for controllably and selectively generating light output from an individual LED is shown in FIG. 18B.

The layout of an exemplary 2×2 sub-pixel is shown in FIG. 18C. In this implementation, the AVSS and AVDD line widths have been configured to be as wide as possible to reduce artifacts from IR (=V_{R}) drops, which allows the BLU pixel to operate without a threshold voltage compensation circuit, allowing wider driver transistors by utilizing the available area and accordingly higher currents.

Although the illustrated implementation describes an amplitude modulation mode of operation, the BLU driver could also be designed to operate either in pulse width mode, amplitude module mode, or both, depending on the mode of operation of the LC panel.

### EXAMPLE EMBODIMENTS

Example 1: A projection system includes at least one source array having a plurality (m×n) of individually addressable sources in which each source has a size Yₛ and an emission cone numerical aperture (NAₛ), at least one concentrator array made of a plurality (m×n) of individual concentrators overlying the source array in which each individual concentrator includes (a) an input facet size Yᵢₙ, and (b) an output facet size Yₒᵤₜ, where the concentrators are configured to condition output light from the source array from NAₛ to a smaller numerical aperture NAₒᵤₜ, a non-emissive display including an array of k×l individually addressable pixels, where k and l are each at least 500 and a pixel size is selected by the desired far-field angular resolution and volume constraints of the projector system, the non-emissive display having an active area XY, an illumination optical system configured to image the output facet of the individual concentrators onto the non-emissive display with a magnification factor M, and a projection lens adapted to collimate light from the non-emissive display, the projection lens having a focal length f and a pupil diameter D.

Example 2: The projection system of Example 1, where Yᵢₙ is equal to Yₛ+/−10%.

Example 3: The projection system of any of Examples 1 and 2, where NAₒᵤₜ=NAₛ(Yᵢₙ/Yₒᵤₜ), and an area of the sum of the m×n individual concentrators output facets is LₓL_{y}, where Lₓ=mYₒᵤₜ and L_{y}=nYₒᵤₜ.

Example 4: The projection system of any of Examples 1-3, where M [Lₓ L_{y}]=[X Y]+/−10%.

Example 5: The projection system of any of Examples 1-4, where a collection numerical aperture NA_{c} of the projection lens is equal to approximately D/2/f, where NA_{c}=NAₛ (Yᵢₙ/Yₒᵤₜ)/M.

Example 6: The projection system of any of Examples 1-5, where each individual source of the array includes at least three sub-sources emitting different colors.

Example 7: The projection system of Example 6, where the sub-sources include mini-LEDs or uLEDs having an emission numerical aperture NAₛ of at least approximately 0.8.

Example 8: The projection system of any of Examples 1-7, where the at least one concentrator array is located on a first side of the non-emissive display and the projection lens is located on a second side of the non-emissive display opposite to the first side.

Example 9: The projection system of any of Examples 1-8, where the projection lens includes a triple pass polarization beam splitter and reflective optics.

Example 10: The projection system of any of Examples 1-9, where the illumination optical system includes at least one polarization beam splitter and one reflecting curved mirror.

Example 11: The projection system of any of Examples 1-10, where a focus condition of the illumination optical system is configured to defocus and smooth edges of the output light incident on the non-emissive display.

Example 12: The projection system of any of Examples 1-11, where each individual concentrator includes a taper segment having a taper length of at least 5× the input facet size Yᵢₙ.

Example 13: The projection system of any of Examples 1-12, including three separate source arrays each having a corresponding concentrator array.

Example 14: A system includes a micro-LED array having a plurality of individually addressable diodes, a concentrator array overlying an output of the micro-LED array and configured to decrease a numerical aperture of light emitted by the micro-LED array, and a non-emissive display panel arranged to receive light from the concentrator array.

Example 15: The system of Example 14, where the concentrator array includes a plurality of tapered optical elements.

Example 16: The system of Example 14, where the concentrator array includes a plurality of compound parabolic collectors.

Example 17: The system of any of Examples 14-16, where the non-emissive display panel includes a liquid crystal panel or a digital micromirror device (DMD).

Example 18: The system of any of Examples 14-17, further including a polarization beam splitter between an output of the concentrator array and an input of the non-emissive display.

Example 19: The system of any of Examples 14-18, where further including a Fresnel lens located proximate to an output of the polarization beam splitter.

Example 20: A projection system includes an illumination source having a plurality of individually addressable illumination components, a concentrator array overlying an output of the illumination source and configured to decrease a numerical aperture of light emitted by the illumination components, and a non-emissive display panel arranged to receive light from the concentrator array.

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed- or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

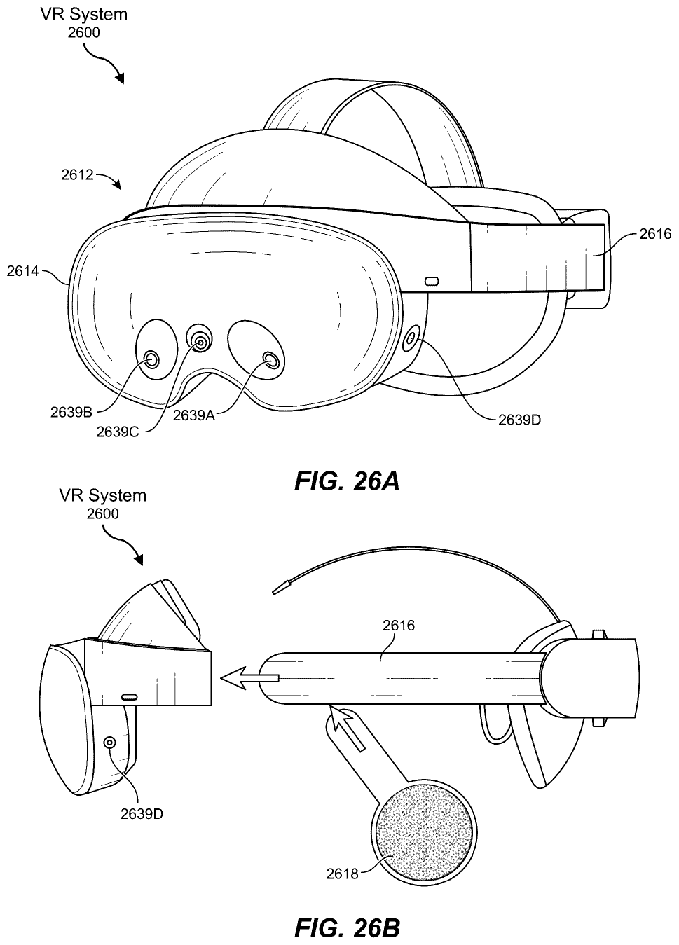

AR systems may be implemented in a variety of different form factors and configurations. Some AR systems may be designed to work without near-eye displays (NEDs). Other AR systems may include a NED that also provides visibility into the real world (such as, e.g., VR system 2600 in FIGS. 26A and 26B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

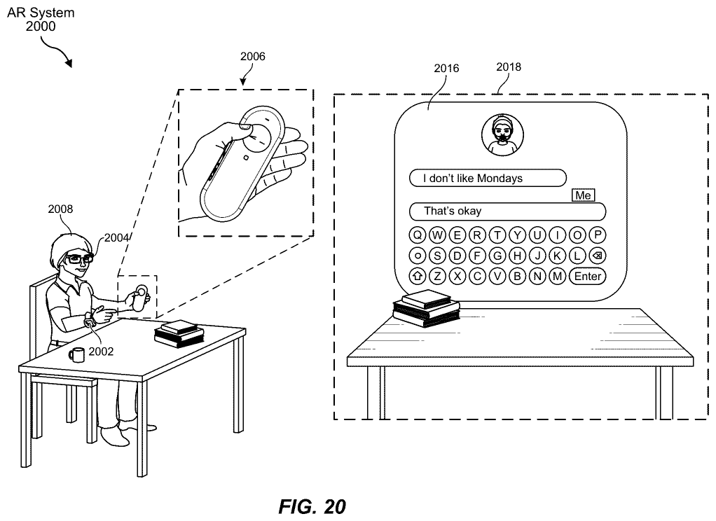

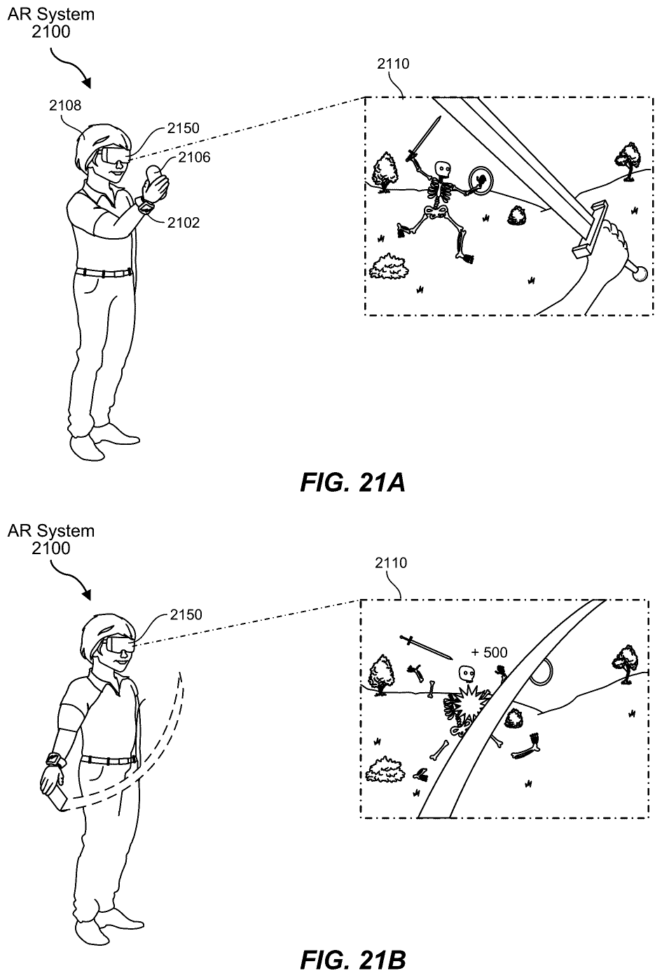

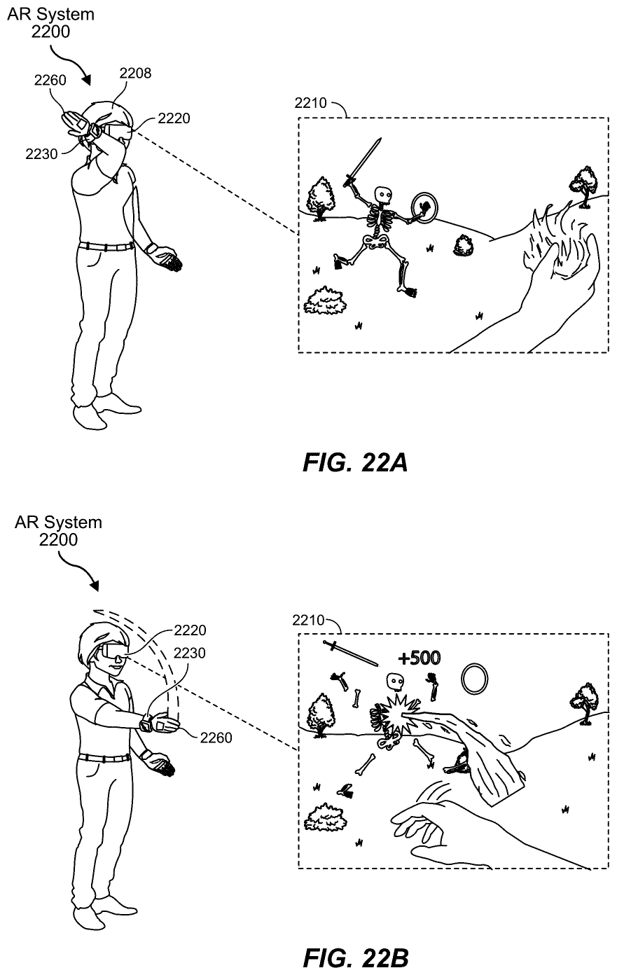

FIGS. 19-22B illustrate example artificial-reality (AR) systems in accordance with some embodiments. FIG. 19 shows a first AR system 1900 and first example user interactions using a wrist-wearable device 1902, a head-wearable device (e.g., AR system 2500), and/or a handheld intermediary processing device (HIPD) 1906. FIG. 20 shows a second AR system 2000 and second example user interactions using a wrist-wearable device 2002, AR glasses 2004, and/or an HIPD 2006. FIGS. 21A and 21B show a third AR system 2100 and third example user 2108 interactions using a wrist-wearable device 2102, a head-wearable device (e.g., VR headset 2150), and/or an HIPD 2106. FIGS. 22A and 22B show a fourth AR system 2200 and fourth example user 2208 interactions using a wrist-wearable device 2230, VR headset 2220, and/or a haptic device 2260 (e.g., wearable gloves).

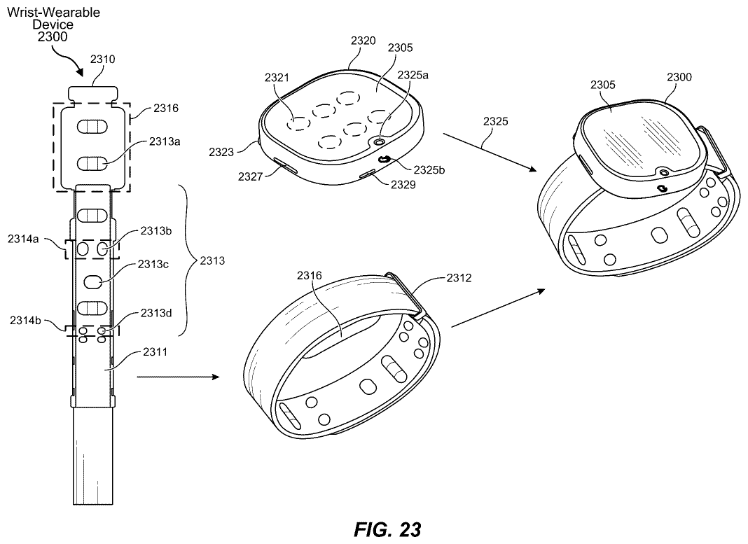

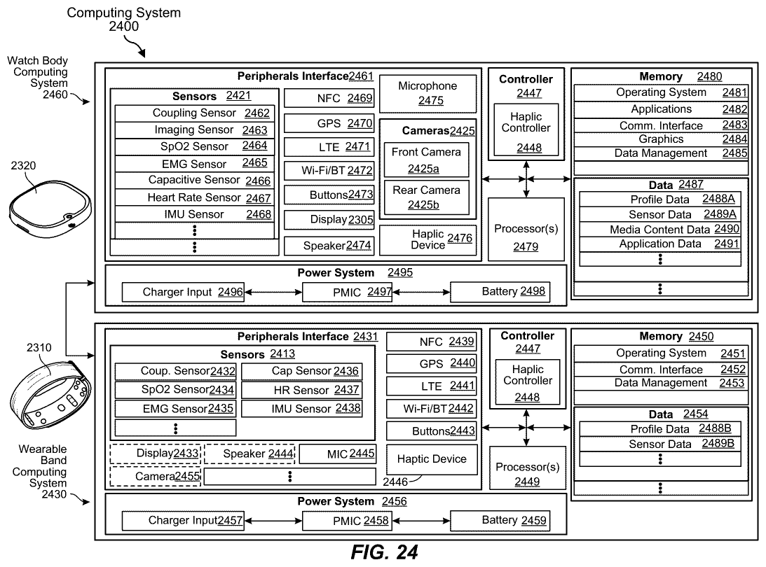

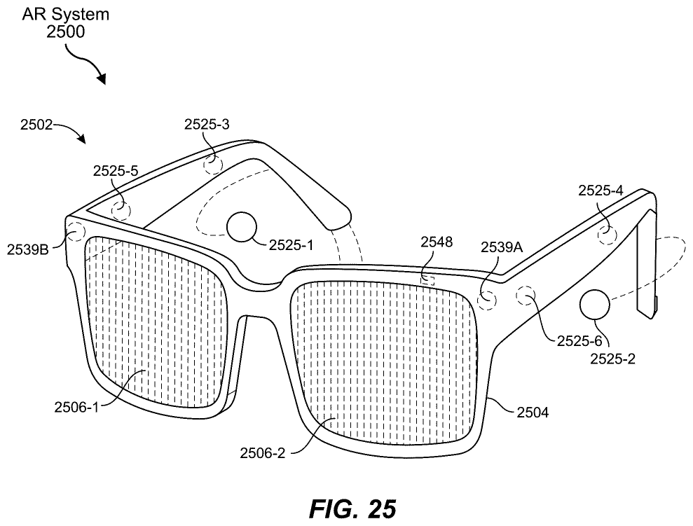

A wrist-wearable device 2300, which can be used for wrist-wearable device 1902, 2002, 2102, 2230, and one or more of its components, are described below in reference to FIGS. 23 and 24; AR system 2500 and VR system 2600, which can respectively be used for AR glasses 1904, 2004 or VR headset 2150, 2220, and their one or more components are described below in reference to FIGS. 25-27.

Referring to FIG. 19, wrist-wearable device 1902, AR glasses 1904, and/or HIPD 1906 can communicatively couple via a network 1925 (e.g., cellular, near field, Wi-Fi, personal area network, wireless LAN, etc.). Additionally, wrist-wearable device 1902, AR glasses 1904, and/or HIPD 1906 can also communicatively couple with one or more servers 1930, computers 1940 (e.g., laptops, computers, etc.), mobile devices 1950 (e.g., smartphones, tablets, etc.), and/or other electronic devices via network 1925 (e.g., cellular, near field, Wi-Fi, personal area network, wireless LAN, etc.).

In FIG. 19, a user 1908 is shown wearing wrist-wearable device 1902 and AR glasses 1904 and having HIPD 1906 on their desk. The wrist-wearable device 1902, AR glasses 1904, and HIPD 1906 facilitate user interaction with an AR environment. In particular, as shown by first AR system 1900, wrist-wearable device 1902, AR glasses 1904, and/or HIPD 1906 cause presentation of one or more avatars 1910, digital representations of contacts 1912, and virtual objects 1914. As discussed below, user 1908 can interact with one or more avatars 1910, digital representations of contacts 1912, and virtual objects 1914 via wrist-wearable device 1902, AR glasses 1904, and/or HIPD 1906.

User 1908 can use any of wrist-wearable device 1902, AR glasses 1904, and/or HIPD 1906 to provide user inputs. For example, user 1908 can perform one or more hand gestures that are detected by wrist-wearable device 1902 (e.g., using one or more EMG sensors and/or IMUs, described below in reference to FIGS. 23 and 24) and/or AR glasses 1904 (e.g., using one or more image sensor or camera, described below in reference to FIGS. 25-27) to provide a user input. Alternatively, or additionally, user 1908 can provide a user input via one or more touch surfaces of wrist-wearable device 1902, AR glasses 1904, HIPD 1906, and/or voice commands captured by a microphone of wrist-wearable device 1902, AR glasses 1904, and/or HIPD 1906. In some embodiments, wrist-wearable device 1902, AR glasses 1904, and/or HIPD 1906 include a digital assistant to help user 1908 in providing a user input (e.g., completing a sequence of operations, suggesting different operations or commands, providing reminders, confirming a command, etc.). In some embodiments, user 1908 can provide a user input via one or more facial gestures and/or facial expressions. For example, cameras of wrist-wearable device 1902, AR glasses 1904, and/or HIPD 1906 can track eyes of user 1908 for navigating a user interface.

Wrist-wearable device 1902, AR glasses 1904, and/or HIPD 1906 can operate alone or in conjunction to allow user 1908 to interact with the AR environment. In some embodiments, HIPD 1906 is configured to operate as a central hub or control center for the wrist-wearable device 1902, AR glasses 1904, and/or another communicatively coupled device. For example, user 1908 can provide an input to interact with the AR environment at any of wrist-wearable device 1902, AR glasses 1904, and/or HIPD 1906, and HIPD 1906 can identify one or more back-end and front-end tasks to cause the performance of the requested interaction and distribute instructions to cause the performance of the one or more back-end and front-end tasks at wrist-wearable device 1902, AR glasses 1904, and/or HIPD 1906. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). As described herein, HIPD 1906 can perform the back-end tasks and provide wrist-wearable device 1902 and/or AR glasses 1904 operational data corresponding to the performed back-end tasks such that wrist-wearable device 1902 and/or AR glasses 1904 can perform the front-end tasks. In this way, HIPD 1906, which has more computational resources and greater thermal headroom than wrist-wearable device 1902 and/or AR glasses 1904, performs computationally intensive tasks and reduces the computer resource utilization and/or power usage of wrist-wearable device 1902 and/or AR glasses 1904.

In the example shown by first AR system 1900, HIPD 1906 identifies one or more back-end tasks and front-end tasks associated with a user request to initiate an AR video call with one or more other users (represented by avatar 1910 and the digital representation of contact 1912) and distributes instructions to cause the performance of the one or more back-end tasks and front-end tasks. In particular, HIPD 1906 performs back-end tasks for processing and/or rendering image data (and other data) associated with the AR video call and provides operational data associated with the performed back-end tasks to AR glasses 1904 such that the AR glasses 1904 perform front-end tasks for presenting the AR video call (e.g., presenting avatar 1910 and digital representation of contact 1912).

In some embodiments, HIPD 1906 can operate as a focal or anchor point for causing the presentation of information. This allows user 1908 to be generally aware of where information is presented. For example, as shown in first AR system 1900, avatar 1910 and the digital representation of contact 1912 are presented above HIPD 1906. In particular, HIPD 1906 and AR glasses 1904 operate in conjunction to determine a location for presenting avatar 1910 and the digital representation of contact 1912. In some embodiments, information can be presented a predetermined distance from HIPD 1906 (e.g., within 5 meters). For example, as shown in first AR system 1900, virtual object 1914 is presented on the desk some distance from HIPD 1906. Similar to the above example, HIPD 1906 and AR glasses 1904 can operate in conjunction to determine a location for presenting virtual object 1914. Alternatively, in some embodiments, presentation of information is not bound by HIPD 1906. More specifically, avatar 1910, digital representation of contact 1912, and virtual object 1914 do not have to be presented within a predetermined distance of HIPD 1906.

User inputs provided at wrist-wearable device 1902, AR glasses 1904, and/or HIPD 1906 are coordinated such that the user can use any device to initiate, continue, and/or complete an operation. For example, user 1908 can provide a user input to AR glasses 1904 to cause AR glasses 1904 to present virtual object 1914 and, while virtual object 1914 is presented by AR glasses 1904, user 1908 can provide one or more hand gestures via wrist-wearable device 1902 to interact and/or manipulate virtual object 1914.

FIG. 20 shows a user 2008 wearing a wrist-wearable device 2002 and AR glasses 2004, and holding an HIPD 2006. In second AR system 2000, the wrist-wearable device 2002, AR glasses 2004, and/or HIPD 2006 are used to receive and/or provide one or more messages to a contact of user 2008. In particular, wrist-wearable device 2002, AR glasses 2004, and/or HIPD 2006 detect and coordinate one or more user inputs to initiate a messaging application and prepare a response to a received message via the messaging application.

In some embodiments, user 2008 initiates, via a user input, an application on wrist-wearable device 2002, AR glasses 2004, and/or HIPD 2006 that causes the application to initiate on at least one device. For example, in second AR system 2000, user 2008 performs a hand gesture associated with a command for initiating a messaging application (represented by messaging user interface 2016), wrist-wearable device 2002 detects the hand gesture and, based on a determination that user 2008 is wearing AR glasses 2004, causes AR glasses 2004 to present a messaging user interface 2016 of the messaging application. AR glasses 2004 can present messaging user interface 2016 to user 2008 via its display (e.g., as shown by a field of view 2018 of user 2008). In some embodiments, the application is initiated and executed on the device (e.g., wrist-wearable device 2002, AR glasses 2004, and/or HIPD 2006) that detects the user input to initiate the application, and the device provides another device operational data to cause the presentation of the messaging application. For example, wrist-wearable device 2002 can detect the user input to initiate a messaging application, initiate and run the messaging application, and provide operational data to AR glasses 2004 and/or HIPD 2006 to cause presentation of the messaging application. Alternatively, the application can be initiated and executed at a device other than the device that detected the user input. For example, wrist-wearable device 2002 can detect the hand gesture associated with initiating the messaging application and cause HIPD 2006 to run the messaging application and coordinate the presentation of the messaging application.

Further, user 2008 can provide a user input provided at wrist-wearable device 2002, AR glasses 2004, and/or HIPD 2006 to continue and/or complete an operation initiated at another device. For example, after initiating the messaging application via wrist-wearable device 2002 and while AR glasses 2004 present messaging user interface 2016, user 2008 can provide an input at HIPD 2006 to prepare a response (e.g., shown by the swipe gesture performed on HIPD 2006). Gestures performed by user 2008 on HIPD 2006 can be provided and/or displayed on another device. For example, a swipe gestured performed on HIPD 2006 is displayed on a virtual keyboard of messaging user interface 2016 displayed by AR glasses 2004.

In some embodiments, wrist-wearable device 2002, AR glasses 2004, HIPD 2006, and/or any other communicatively coupled device can present one or more notifications to user 2008. The notification can be an indication of a new message, an incoming call, an application update, a status update, etc. User 2008 can select the notification via wrist-wearable device 2002, AR glasses 2004, and/or HIPD 2006 and can cause presentation of an application or operation associated with the notification on at least one device. For example, user 2008 can receive a notification that a message was received at wrist-wearable device 2002, AR glasses 2004, HIPD 2006, and/or any other communicatively coupled device and can then provide a user input at wrist-wearable device 2002, AR glasses 2004, and/or HIPD 2006 to review the notification, and the device detecting the user input can cause an application associated with the notification to be initiated and/or presented at wrist-wearable device 2002, AR glasses 2004, and/or HIPD 2006.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 2004 can present to user 2008 game application data, and HIPD 2006 can be used as a controller to provide inputs to the game. Similarly, user 2008 can use wrist-wearable device 2002 to initiate a camera of AR glasses 2004, and user 308 can use wrist-wearable device 2002, AR glasses 2004, and/or HIPD 2006 to manipulate the image capture (e.g., zoom in or out, apply filters, etc.) and capture image data.

Users may interact with the devices disclosed herein in a variety of ways. For example, as shown in FIGS. 21A and 21B, a user 2108 may interact with an AR system 2100 by donning a VR headset 2150 while holding HIPD 2106 and wearing wrist-wearable device 2102. In this example, AR system 2100 may enable a user to interact with a game 2110 by swiping their arm. One or more of VR headset 2150, HIPD 2106, and wrist-wearable device 2102 may detect this gesture and, in response, may display a sword strike in game 2110. Similarly, in FIGS. 22A and 22B, a user 2208 may interact with an AR system 2200 by donning a VR headset 2220 while wearing haptic device 2260 and wrist-wearable device 2230. In this example, AR system 2200 may enable a user to interact with a game 2210 by swiping their arm. One or more of VR headset 2220, haptic device 2260, and wrist-wearable device 2230 may detect this gesture and, in response, may display a spell being cast in game 2110.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiogram sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configured to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 2502.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 23 and 24 illustrate an example wrist-wearable device 2300 and an example computer system 2400, in accordance with some embodiments. Wrist-wearable device 2300 is an instance of wearable device 1902 described in FIG. 19 herein, such that the wearable device 1902 should be understood to have the features of the wrist-wearable device 2300 and vice versa. FIG. 24 illustrates components of the wrist-wearable device 2300, which can be used individually or in combination, including combinations that include other electronic devices and/or electronic components.

FIG. 23 shows a wearable band 2310 and a watch body 2320 (or capsule) being coupled, as discussed below, to form wrist-wearable device 2300. Wrist-wearable device 2300 can perform various functions and/or operations associated with navigating through user interfaces and selectively opening applications as well as the functions and/or operations described above with reference to FIGS. 19-22B.

As will be described in more detail below, operations executed by wrist-wearable device 2300 can include (i) presenting content to a user (e.g., displaying visual content via a display 2305), (ii) detecting (e.g., sensing) user input (e.g., sensing a touch on peripheral button 2323 and/or at a touch screen of the display 2305, a hand gesture detected by sensors (e.g., biopotential sensors)), (iii) sensing biometric data (e.g., neuromuscular signals, heart rate, temperature, sleep, etc.) via one or more sensors 2313, messaging (e.g., text, speech, video, etc.); image capture via one or more imaging devices or cameras 2325, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 2320, independently in wearable band 2310, and/or via an electronic communication between watch body 2320 and wearable band 2310. In some embodiments, functions can be executed on wrist-wearable device 2300 while an AR environment is being presented (e.g., via one of AR systems 1900 to 2200). The wearable devices described herein can also be used with other types of AR environments.

Wearable band 2310 can be configured to be worn by a user such that an inner surface of a wearable structure 2311 of wearable band 2310 is in contact with the user's skin. In this example, when worn by a user, sensors 2313 may contact the user's skin. In some examples, one or more of sensors 2313 can sense biometric data such as a user's heart rate, a saturated oxygen level, temperature, sweat level, neuromuscular signals, or a combination thereof. One or more of sensors 2313 can also sense data about a user's environment including a user's motion, altitude, location, orientation, gait, acceleration, position, or a combination thereof. In some embodiment, one or more of sensors 2313 can be configured to track a position and/or motion of wearable band 2310. One or more of sensors 2313 can include any of the sensors defined above and/or discussed below with respect to FIG. 23.

One or more of sensors 2313 can be distributed on an inside and/or an outside surface of wearable band 2310. In some embodiments, one or more of sensors 2313 are uniformly spaced along wearable band 2310. Alternatively, in some embodiments, one or more of sensors 2313 are positioned at distinct points along wearable band 2310. As shown in FIG. 23, one or more of sensors 2313 can be the same or distinct. For example, in some embodiments, one or more of sensors 2313 can be shaped as a pill (e.g., sensor 2313a), an oval, a circle a square, an oblong (e.g., sensor 2313c) and/or any other shape that maintains contact with the user's skin (e.g., such that neuromuscular signal and/or other biometric data can be accurately measured at the user's skin). In some embodiments, one or more sensors of 2313 are aligned to form pairs of sensors (e.g., for sensing neuromuscular signals based on differential sensing within each respective sensor). For example, sensor 2313b may be aligned with an adjacent sensor to form sensor pair 2314a and sensor 2313d may be aligned with an adjacent sensor to form sensor pair 2314b. In some embodiments, wearable band 2310 does not have a sensor pair. Alternatively, in some embodiments, wearable band 2310 has a predetermined number of sensor pairs (one pair of sensors, three pairs of sensors, four pairs of sensors, six pairs of sensors, sixteen pairs of sensors, etc.).

Wearable band 2310 can include any suitable number of sensors 2313. In some embodiments, the number and arrangement of sensors 2313 depends on the particular application for which wearable band 2310 is used. For instance, wearable band 2310 can be configured as an armband, wristband, or chest-band that include a plurality of sensors 2313 with different number of sensors 2313, a variety of types of individual sensors with the plurality of sensors 2313, and different arrangements for each use case, such as medical use cases as compared to gaming or general day-to-day use cases.

In accordance with some embodiments, wearable band 2310 further includes an electrical ground electrode and a shielding electrode. The electrical ground and shielding electrodes, like the sensors 2313, can be distributed on the inside surface of the wearable band 2310 such that they contact a portion of the user's skin. For example, the electrical ground and shielding electrodes can be at an inside surface of a coupling mechanism 2316 or an inside surface of a wearable structure 2311. The electrical ground and shielding electrodes can be formed and/or use the same components as sensors 2313. In some embodiments, wearable band 2310 includes more than one electrical ground electrode and more than one shielding electrode.

Sensors 2313 can be formed as part of wearable structure 2311 of wearable band 2310. In some embodiments, sensors 2313 are flush or substantially flush with wearable structure 2311 such that they do not extend beyond the surface of wearable structure 2311. While flush with wearable structure 2311, sensors 2313 are still configured to contact the user's skin (e.g., via a skin-contacting surface). Alternatively, in some embodiments, sensors 2313 extend beyond wearable structure 2311 a predetermined distance (e.g., 0.1-2 mm) to make contact and depress into the user's skin. In some embodiment, sensors 2313 are coupled to an actuator (not shown) configured to adjust an extension height (e.g., a distance from the surface of wearable structure 2311) of sensors 2313 such that sensors 2313 make contact and depress into the user's skin. In some embodiments, the actuators adjust the extension height between 0.01 mm-1.2 mm. This may allow a user to customize the positioning of sensors 2313 to improve the overall comfort of the wearable band 2310 when worn while still allowing sensors 2313 to contact the user's skin. In some embodiments, sensors 2313 are indistinguishable from wearable structure 2311 when worn by the user.

Wearable structure 2311 can be formed of an elastic material, elastomers, etc., configured to be stretched and fitted to be worn by the user. In some embodiments, wearable structure 2311 is a textile or woven fabric. As described above, sensors 2313 can be formed as part of a wearable structure 2311. For example, sensors 2313 can be molded into the wearable structure 2311, be integrated into a woven fabric (e.g., sensors 2313 can be sewn into the fabric and mimic the pliability of fabric and can and/or be constructed from a series woven strands of fabric).

Wearable structure 2311 can include flexible electronic connectors that interconnect sensors 2313, the electronic circuitry, and/or other electronic components (described below in reference to FIG. 24) that are enclosed in wearable band 2310. In some embodiments, the flexible electronic connectors are configured to interconnect sensors 2313, the electronic circuitry, and/or other electronic components of wearable band 2310 with respective sensors and/or other electronic components of another electronic device (e.g., watch body 2320). The flexible electronic connectors are configured to move with wearable structure 2311 such that the user adjustment to wearable structure 2311 (e.g., resizing, pulling, folding, etc.) does not stress or strain the electrical coupling of components of wearable band 2310.

As described above, wearable band 2310 is configured to be worn by a user. In particular, wearable band 2310 can be shaped or otherwise manipulated to be worn by a user. For example, wearable band 2310 can be shaped to have a substantially circular shape such that it can be configured to be worn on the user's lower arm or wrist. Alternatively, wearable band 2310 can be shaped to be worn on another body part of the user, such as the user's upper arm (e.g., around a bicep), forearm, chest, legs, etc. Wearable band 2310 can include a retaining mechanism 2312 (e.g., a buckle, a hook and loop fastener, etc.) for securing wearable band 2310 to the user's wrist or other body part. While wearable band 2310 is worn by the user, sensors 2313 sense data (referred to as sensor data) from the user's skin. In some examples, sensors 2313 of wearable band 2310 obtain (e.g., sense and record) neuromuscular signals.

The sensed data (e.g., sensed neuromuscular signals) can be used to detect and/or determine the user's intention to perform certain motor actions. In some examples, sensors 2313 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 2305 of wrist-wearable device 2300 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 2313 can be used to provide a user with an enhanced interaction with a physical object (e.g., devices communicatively coupled with wearable band 2310) and/or a virtual object in an artificial-reality application generated by an artificial-reality system (e.g., user interface objects presented on the display 2305, or another computing device (e.g., a smartphone)).

In some embodiments, wearable band 2310 includes one or more haptic devices 2446 (e.g., a vibratory haptic actuator) that are configured to provide haptic feedback (e.g., a cutaneous and/or kinesthetic sensation, etc.) to the user's skin. Sensors 2313 and/or haptic devices 2446 (shown in FIG. 24) can be configured to operate in conjunction with multiple applications including, without limitation, health monitoring, social media, games, and artificial reality (e.g., the applications associated with artificial reality).

Wearable band 2310 can also include coupling mechanism 2316 for detachably coupling a capsule (e.g., a computing unit) or watch body 2320 (via a coupling surface of the watch body 2320) to wearable band 2310. For example, a cradle or a shape of coupling mechanism 2316 can correspond to shape of watch body 2320 of wrist-wearable device 2300. In particular, coupling mechanism 2316 can be configured to receive a coupling surface proximate to the bottom side of watch body 2320 (e.g., a side opposite to a front side of watch body 2320 where display 2305 is located), such that a user can push watch body 2320 downward into coupling mechanism 2316 to attach watch body 2320 to coupling mechanism 2316. In some embodiments, coupling mechanism 2316 can be configured to receive a top side of the watch body 2320 (e.g., a side proximate to the front side of watch body 2320 where display 2305 is located) that is pushed upward into the cradle, as opposed to being pushed downward into coupling mechanism 2316. In some embodiments, coupling mechanism 2316 is an integrated component of wearable band 2310 such that wearable band 2310 and coupling mechanism 2316 are a single unitary structure. In some embodiments, coupling mechanism 2316 is a type of frame or shell that allows watch body 2320 coupling surface to be retained within or on wearable band 2310 coupling mechanism 2316 (e.g., a cradle, a tracker band, a support base, a clasp, etc.).

Coupling mechanism 2316 can allow for watch body 2320 to be detachably coupled to the wearable band 2310 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 2320 to wearable band 2310 and to decouple the watch body 2320 from the wearable band 2310. For example, a user can twist, slide, turn, push, pull, or rotate watch body 2320 relative to wearable band 2310, or a combination thereof, to attach watch body 2320 to wearable band 2310 and to detach watch body 2320 from wearable band 2310. Alternatively, as discussed below, in some embodiments, the watch body 2320 can be decoupled from the wearable band 2310 by actuation of a release mechanism 2329.

Wearable band 2310 can be coupled with watch body 2320 to increase the functionality of wearable band 2310 (e.g., converting wearable band 2310 into wrist-wearable device 2300, adding an additional computing unit and/or battery to increase computational resources and/or a battery life of wearable band 2310, adding additional sensors to improve sensed data, etc.). As described above, wearable band 2310 and coupling mechanism 2316 are configured to operate independently (e.g., execute functions independently) from watch body 2320. For example, coupling mechanism 2316 can include one or more sensors 2313 that contact a user's skin when wearable band 2310 is worn by the user, with or without watch body 2320 and can provide sensor data for determining control commands.

A user can detach watch body 2320 from wearable band 2310 to reduce the encumbrance of wrist-wearable device 2300 to the user. For embodiments in which watch body 2320 is removable, watch body 2320 can be referred to as a removable structure, such that in these embodiments wrist-wearable device 2300 includes a wearable portion (e.g., wearable band 2310) and a removable structure (e.g., watch body 2320).

Turning to watch body 2320, in some examples watch body 2320 can have a substantially rectangular or circular shape. Watch body 2320 is configured to be worn by the user on their wrist or on another body part. More specifically, watch body 2320 is sized to be easily carried by the user, attached on a portion of the user's clothing, and/or coupled to wearable band 2310 (forming the wrist-wearable device 2300). As described above, watch body 2320 can have a shape corresponding to coupling mechanism 2316 of wearable band 2310. In some embodiments, watch body 2320 includes a single release mechanism 2329 or multiple release mechanisms (e.g., two release mechanisms 2329 positioned on opposing sides of watch body 2320, such as spring-loaded buttons) for decoupling watch body 2320 from wearable band 2310. Release mechanism 2329 can include, without limitation, a button, a knob, a plunger, a handle, a lever, a fastener, a clasp, a dial, a latch, or a combination thereof.

A user can actuate release mechanism 2329 by pushing, turning, lifting, depressing, shifting, or performing other actions on release mechanism 2329. Actuation of release mechanism 2329 can release (e.g., decouple) watch body 2320 from coupling mechanism 2316 of wearable band 2310, allowing the user to use watch body 2320 independently from wearable band 2310 and vice versa. For example, decoupling watch body 2320 from wearable band 2310 can allow a user to capture images using rear-facing camera 2325b. Although release mechanism 2329 is shown positioned at a corner of watch body 2320, release mechanism 2329 can be positioned anywhere on watch body 2320 that is convenient for the user to actuate. In addition, in some embodiments, wearable band 2310 can also include a respective release mechanism for decoupling watch body 2320 from coupling mechanism 2316. In some embodiments, release mechanism 2329 is optional and watch body 2320 can be decoupled from coupling mechanism 2316 as described above (e.g., via twisting, rotating, etc.).

Watch body 2320 can include one or more peripheral buttons 2323 and 2327 for performing various operations at watch body 2320. For example, peripheral buttons 2323 and 2327 can be used to turn on or wake (e.g., transition from a sleep state to an active state) display 2305, unlock watch body 2320, increase or decrease a volume, increase or decrease a brightness, interact with one or more applications, interact with one or more user interfaces, etc. Additionally or alternatively, in some embodiments, display 2305 operates as a touch screen and allows the user to provide one or more inputs for interacting with watch body 2320.

In some embodiments, watch body 2320 includes one or more sensors 2321. Sensors 2321 of watch body 2320 can be the same or distinct from sensors 2313 of wearable band 2310. Sensors 2321 of watch body 2320 can be distributed on an inside and/or an outside surface of watch body 2320. In some embodiments, sensors 2321 are configured to contact a user's skin when watch body 2320 is worn by the user. For example, sensors 2321 can be placed on the bottom side of watch body 2320 and coupling mechanism 2316 can be a cradle with an opening that allows the bottom side of watch body 2320 to directly contact the user's skin. Alternatively, in some embodiments, watch body 2320 does not include sensors that are configured to contact the user's skin (e.g., including sensors internal and/or external to the watch body 2320 that are configured to sense data of watch body 2320 and the surrounding environment). In some embodiments, sensors 2321 are configured to track a position and/or motion of watch body 2320.

Watch body 2320 and wearable band 2310 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 2320 and wearable band 2310 can share data sensed by sensors 2313 and 2321, as well as application and device specific information (e.g., active and/or available applications, output devices (e.g., displays, speakers, etc.), input devices (e.g., touch screens, microphones, imaging sensors, etc.).

In some embodiments, watch body 2320 can include, without limitation, a front-facing camera 2325a and/or a rear-facing camera 2325b, sensors 2321 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 2463), a touch sensor, a sweat sensor, etc.). In some embodiments, watch body 2320 can include one or more haptic devices 2476 (e.g., a vibratory haptic actuator) that is configured to provide haptic feedback (e.g., a cutaneous and/or kinesthetic sensation, etc.) to the user. Sensors 2421 and/or haptic device 2476 can also be configured to operate in conjunction with multiple applications including, without limitation, health monitoring applications, social media applications, game applications, and artificial reality applications (e.g., the applications associated with artificial reality).

As described above, watch body 2320 and wearable band 2310, when coupled, can form wrist-wearable device 2300. When coupled, watch body 2320 and wearable band 2310 may operate as a single device to execute functions (operations, detections, communications, etc.) described herein. In some embodiments, each device may be provided with particular instructions for performing the one or more operations of wrist-wearable device 2300. For example, in accordance with a determination that watch body 2320 does not include neuromuscular signal sensors, wearable band 2310 can include alternative instructions for performing associated instructions (e.g., providing sensed neuromuscular signal data to watch body 2320 via a different electronic device). Operations of wrist-wearable device 2300 can be performed by watch body 2320 alone or in conjunction with wearable band 2310 (e.g., via respective processors and/or hardware components) and vice versa. In some embodiments, operations of wrist-wearable device 2300, watch body 2320, and/or wearable band 2310 can be performed in conjunction with one or more processors and/or hardware components.

As described below with reference to the block diagram of FIG. 24, wearable band 2310 and/or watch body 2320 can each include independent resources required to independently execute functions. For example, wearable band 2310 and/or watch body 2320 can each include a power source (e.g., a battery), a memory, data storage, a processor (e.g., a central processing unit (CPU)), communications, a light source, and/or input/output devices.

FIG. 24 shows block diagrams of a computing system 2430 corresponding to wearable band 2310 and a computing system 2460 corresponding to watch body 2320 according to some embodiments. Computing system 2400 of wrist-wearable device 2300 may include a combination of components of wearable band computing system 2430 and watch body computing system 2460, in accordance with some embodiments.

Watch body 2320 and/or wearable band 2310 can include one or more components shown in watch body computing system 2460. In some embodiments, a single integrated circuit may include all or a substantial portion of the components of watch body computing system 2460 included in a single integrated circuit. Alternatively, in some embodiments, components of the watch body computing system 2460 may be included in a plurality of integrated circuits that are communicatively coupled. In some embodiments, watch body computing system 2460 may be configured to couple (e.g., via a wired or wireless connection) with wearable band computing system 2430, which may allow the computing systems to share components, distribute tasks, and/or perform other operations described herein (individually or as a single device).

Watch body computing system 2460 can include one or more processors 2479, a controller 2477, a peripherals interface 2461, a power system 2495, and memory (e.g., a memory 2480).

Power system 2495 can include a charger input 2496, a power-management integrated circuit (PMIC) 2497, and a battery 2498. In some embodiments, a watch body 2320 and a wearable band 2310 can have respective batteries (e.g., battery 2498 and 2459) and can share power with each other. Watch body 2320 and wearable band 2310 can receive a charge using a variety of techniques. In some embodiments, watch body 2320 and wearable band 2310 can use a wired charging assembly (e.g., power cords) to receive the charge. Alternatively, or in addition, watch body 2320 and/or wearable band 2310 can be configured for wireless charging. For example, a portable charging device can be designed to mate with a portion of watch body 2320 and/or wearable band 2310 and wirelessly deliver usable power to battery 2498 of watch body 2320 and/or battery 2459 of wearable band 2310. Watch body 2320 and wearable band 2310 can have independent power systems (e.g., power system 2495 and 2456, respectively) to enable each to operate independently. Watch body 2320 and wearable band 2310 can also share power (e.g., one can charge the other) via respective PMICs (e.g., PMICs 2497 and 2458) and charger inputs (e.g., 2457 and 2496) that can share power over power and ground conductors and/or over wireless charging antennas.

In some embodiments, peripherals interface 2461 can include one or more sensors 2421. Sensors 2421 can include one or more coupling sensors 2462 for detecting when watch body 2320 is coupled with another electronic device (e.g., a wearable band 2310). Sensors 2421 can include one or more imaging sensors 2463 (e.g., one or more of cameras 2425, and/or separate imaging sensors 2463 (e.g., thermal-imaging sensors)). In some embodiments, sensors 2421 can include one or more SpO2 sensors 2464. In some embodiments, sensors 2421 can include one or more biopotential-signal sensors (e.g., EMG sensors 2465, which may be disposed on an interior, user-facing portion of watch body 2320 and/or wearable band 2310). In some embodiments, sensors 2421 may include one or more capacitive sensors 2466. In some embodiments, sensors 2421 may include one or more heart rate sensors 2467. In some embodiments, sensors 2421 may include one or more IMU sensors 2468. In some embodiments, one or more IMU sensors 2468 can be configured to detect movement of a user's hand or other location where watch body 2320 is placed or held.

In some embodiments, one or more of sensors 2421 may provide an example human-machine interface. For example, a set of neuromuscular sensors, such as EMG sensors 2465, may be arranged circumferentially around wearable band 2310 with an interior surface of EMG sensors 2465 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 2310 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 2479. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 2465 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 2461 includes a near-field communication (NFC) component 2469, a global-position system (GPS) component 2470, a long-term evolution (LTE) component 2471, and/or a Wi-Fi and/or Bluetooth communication component 2472. In some embodiments, peripherals interface 2461 includes one or more buttons 2473 (e.g., peripheral buttons 2323 and 2327 in FIG. 23), which, when selected by a user, cause operation to be performed at watch body 2320. In some embodiments, the peripherals interface 2461 includes one or more indicators, such as a light emitting diode (LED), to provide a user with visual indicators (e.g., message received, low battery, active microphone and/or camera, etc.).

Watch body 2320 can include at least one display 2305 for displaying visual representations of information or data to a user, including user-interface elements and/or three-dimensional virtual objects. The display can also include a touch screen for inputting user inputs, such as touch gestures, swipe gestures, and the like. Watch body 2320 can include at least one speaker 2474 and at least one microphone 2475 for providing audio signals to the user and receiving audio input from the user. The user can provide user inputs through microphone 2475 and can also receive audio output from speaker 2474 as part of a haptic event provided by haptic controller 2478. Watch body 2320 can include at least one camera 2425, including a front camera 2425a and a rear camera 2425b. Cameras 2425 can include ultra-wide-angle cameras, wide angle cameras, fish-eye cameras, spherical cameras, telephoto cameras, depth-sensing cameras, or other types of cameras.

Watch body computing system 2460 can include one or more haptic controllers 2478 and associated componentry (e.g., haptic devices 2476) for providing haptic events at watch body 2320 (e.g., a vibrating sensation or audio output in response to an event at the watch body 2320). Haptic controllers 2478 can communicate with one or more haptic devices 2476, such as electroacoustic devices, including a speaker of the one or more speakers 2474 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 2478 can provide haptic events to that are capable of being sensed by a user of watch body 2320. In some embodiments, one or more haptic controllers 2478 can receive input signals from an application of applications 2482.

In some embodiments, wearable band computing system 2430 and/or watch body computing system 2460 can include memory 2480, which can be controlled by one or more memory controllers of controllers 2477. In some embodiments, software components stored in memory 2480 include one or more applications 2482 configured to perform operations at the watch body 2320. In some embodiments, one or more applications 2482 may include games, word processors, messaging applications, calling applications, web browsers, social media applications, media streaming applications, financial applications, calendars, clocks, etc. In some embodiments, software components stored in memory 2480 include one or more communication interface modules 2483 as defined above. In some embodiments, software components stored in memory 2480 include one or more graphics modules 2484 for rendering, encoding, and/or decoding audio and/or visual data and one or more data management modules 2485 for collecting, organizing, and/or providing access to data 2487 stored in memory 2480. In some embodiments, one or more of applications 2482 and/or one or more modules can work in conjunction with one another to perform various tasks at the watch body 2320.

In some embodiments, software components stored in memory 2480 can include one or more operating systems 2481 (e.g., a Linux-based operating system, an Android operating system, etc.). Memory 2480 can also include data 2487. Data 2487 can include profile data 2488A, sensor data 2489A, media content data 2490, and application data 2491.

It should be appreciated that watch body computing system 2460 is an example of a computing system within watch body 2320, and that watch body 2320 can have more or fewer components than shown in watch body computing system 2460, can combine two or more components, and/or can have a different configuration and/or arrangement of the components. The various components shown in watch body computing system 2460 are implemented in hardware, software, firmware, or a combination thereof, including one or more signal processing and/or application-specific integrated circuits.

Turning to the wearable band computing system 2430, one or more components that can be included in wearable band 2310 are shown. Wearable band computing system 2430 can include more or fewer components than shown in watch body computing system 2460, can combine two or more components, and/or can have a different configuration and/or arrangement of some or all of the components. In some embodiments, all, or a substantial portion of the components of wearable band computing system 2430 are included in a single integrated circuit. Alternatively, in some embodiments, components of wearable band computing system 2430 are included in a plurality of integrated circuits that are communicatively coupled. As described above, in some embodiments, wearable band computing system 2430 is configured to couple (e.g., via a wired or wireless connection) with watch body computing system 2460, which allows the computing systems to share components, distribute tasks, and/or perform other operations described herein (individually or as a single device).

Wearable band computing system 2430, similar to watch body computing system 2460, can include one or more processors 2449, one or more controllers 2447 (including one or more haptics controllers 2448), a peripherals interface 2431 that can includes one or more sensors 2413 and other peripheral devices, a power source (e.g., a power system 2456), and memory (e.g., a memory 2450) that includes an operating system (e.g., an operating system 2451), data (e.g., data 2454 including profile data 2488B, sensor data 2489B, etc.), and one or more modules (e.g., a communications interface module 2452, a data management module 2453, etc.).

One or more of sensors 2413 can be analogous to sensors 2421 of watch body computing system 2460. For example, sensors 2413 can include one or more coupling sensors 2432, one or more SpO2 sensors 2434, one or more EMG sensors 2435, one or more capacitive sensors 2436, one or more heart rate sensors 2437, and one or more IMU sensors 2438.

Peripherals interface 2431 can also include other components analogous to those included in peripherals interface 2461 of watch body computing system 2460, including an NFC component 2439, a GPS component 2440, an LTE component 2441, a Wi-Fi and/or Bluetooth communication component 2442, and/or one or more haptic devices 2446 as described above in reference to peripherals interface 2461. In some embodiments, peripherals interface 2431 includes one or more buttons 2443, a display 2433, a speaker 2444, a microphone 2445, and a camera 2455. In some embodiments, peripherals interface 2431 includes one or more indicators, such as an LED.

It should be appreciated that wearable band computing system 2430 is an example of a computing system within wearable band 2310, and that wearable band 2310 can have more or fewer components than shown in wearable band computing system 2430, combine two or more components, and/or have a different configuration and/or arrangement of the components. The various components shown in wearable band computing system 2430 can be implemented in one or more of a combination of hardware, software, or firmware, including one or more signal processing and/or application-specific integrated circuits.

Wrist-wearable device 2300 with respect to FIG. 23 is an example of wearable band 2310 and watch body 2320 coupled together, so wrist-wearable device 2300 will be understood to include the components shown and described for wearable band computing system 2430 and watch body computing system 2460. In some embodiments, wrist-wearable device 2300 has a split architecture (e.g., a split mechanical architecture, a split electrical architecture, etc.) between watch body 2320 and wearable band 2310. In other words, all of the components shown in wearable band computing system 2430 and watch body computing system 2460 can be housed or otherwise disposed in a combined wrist-wearable device 2300 or within individual components of watch body 2320, wearable band 2310, and/or portions thereof (e.g., a coupling mechanism 2316 of wearable band 2310).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 2300 can be used in conjunction with a head-wearable device (e.g., AR system 2500 and VR system 2600), and wrist-wearable device 2300 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR system 2500 and VR system 2600.

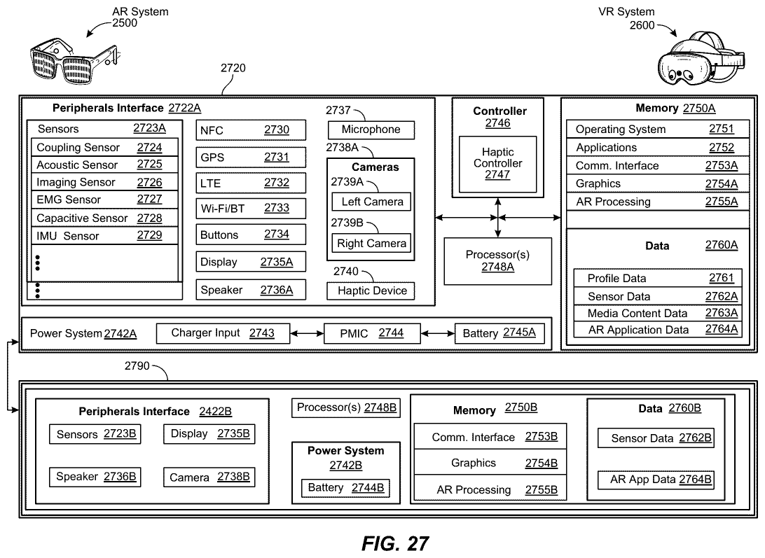

FIGS. 25 to 27 show example artificial-reality systems, which can be used as or in connection with wrist-wearable device 2300. In some embodiments, AR system 2500 includes an eyewear device 2502, as shown in FIG. 25. In some embodiments, VR system 2600 includes a head-mounted display (HMD) 2612, as shown in FIGS. 26A and 26B. In some embodiments, AR system 2500 and VR system 2600 can include one or more analogous components (e.g., components for presenting interactive artificial-reality environments, such as processors, memory, and/or presentation devices, including one or more displays and/or one or more waveguides), some of which are described in more detail with respect to FIG. 27. As described herein, a head-wearable device can include components of eyewear device 2502 and/or head-mounted display 2612. Some embodiments of head-wearable devices do not include any displays, including any of the displays described with respect to AR system 2500 and/or VR system 2600. While the example artificial-reality systems are respectively described herein as AR system 2500 and VR system 2600, either or both of the example AR systems described herein can be configured to present fully-immersive virtual-reality scenes presented in substantially all of a user's field of view or subtler augmented-reality scenes that are presented within a portion, less than all, of the user's field of view.

FIG. 25 show an example visual depiction of AR system 2500, including an eyewear device 2502 (which may also be described herein as augmented-reality glasses, and/or smart glasses). AR system 2500 can include additional electronic components that are not shown in FIG. 25, such as a wearable accessory device and/or an intermediary processing device, in electronic communication or otherwise configured to be used in conjunction with the eyewear device 2502. In some embodiments, the wearable accessory device and/or the intermediary processing device may be configured to couple with eyewear device 2502 via a coupling mechanism in electronic communication with a coupling sensor 2724 (FIG. 27), where coupling sensor 2724 can detect when an electronic device becomes physically or electronically coupled with eyewear device 2502. In some embodiments, eyewear device 2502 can be configured to couple to a housing 2790 (FIG. 27), which may include one or more additional coupling mechanisms configured to couple with additional accessory devices. The components shown in FIG. 25 can be implemented in hardware, software, firmware, or a combination thereof, including one or more signal-processing components and/or application-specific integrated circuits (ASICs).

Eyewear device 2502 includes mechanical glasses components, including a frame 2504 configured to hold one or more lenses (e.g., one or both lenses 2506-1 and 2506-2). One of ordinary skill in the art will appreciate that eyewear device 2502 can include additional mechanical components, such as hinges configured to allow portions of frame 2504 of eyewear device 2502 to be folded and unfolded, a bridge configured to span the gap between lenses 2506-1 and 2506-2 and rest on the user's nose, nose pads configured to rest on the bridge of the nose and provide support for eyewear device 2502, earpieces configured to rest on the user's ears and provide additional support for eyewear device 2502, temple arms configured to extend from the hinges to the earpieces of eyewear device 2502, and the like. One of ordinary skill in the art will further appreciate that some examples of AR system 2500 can include none of the mechanical components described herein. For example, smart contact lenses configured to present artificial reality to users may not include any components of eyewear device 2502.

Eyewear device 2502 includes electronic components, many of which will be described in more detail below with respect to FIG. 10. Some example electronic components are illustrated in FIG. 25, including acoustic sensors 2525-1, 2525-2, 2525-3, 2525-4, 2525-5, and 2525-6, which can be distributed along a substantial portion of the frame 2504 of eyewear device 2502. Eyewear device 2502 also includes a left camera 2539A and a right camera 2539B, which are located on different sides of the frame 2504. Eyewear device 2502 also includes a processor 2548 (or any other suitable type or form of integrated circuit) that is embedded into a portion of the frame 2504.

FIGS. 26A and 26B show a VR system 2600 that includes a head-mounted display (HMD) 2612 (e.g., also referred to herein as an artificial-reality headset, a head-wearable device, a VR headset, etc.), in accordance with some embodiments. As noted, some artificial-reality systems (e.g., AR system 2500) may, instead of blending an artificial reality with actual reality, substantially replace one or more of a user's visual and/or other sensory perceptions of the real world with a virtual experience (e.g., AR systems 2100 and 2200).

HMD 2612 includes a front body 2614 and a frame 2616 (e.g., a strap or band) shaped to fit around a user's head. In some embodiments, front body 2614 and/or frame 2616 include one or more electronic elements for facilitating presentation of and/or interactions with an AR and/or VR system (e.g., displays, IMUs, tracking emitter or detectors). In some embodiments, HMD 2612 includes output audio transducers (e.g., an audio transducer 2618), as shown in FIG. 26B. In some embodiments, one or more components, such as the output audio transducer(s) 2618 and frame 2616, can be configured to attach and detach (e.g., are detachably attachable) to HMD 2612 (e.g., a portion or all of frame 2616, and/or audio transducer 2618), as shown in FIG. 26B. In some embodiments, coupling a detachable component to HMD 2612 causes the detachable component to come into electronic communication with HMD 2612.

FIGS. 26A and 26B also show that VR system 2600 includes one or more cameras, such as left camera 2639A and right camera 2639B, which can be analogous to left and right cameras 2539A and 2539B on frame 2504 of eyewear device 2502. In some embodiments, VR system 2600 includes one or more additional cameras (e.g., cameras 2639C and 2639D), which can be configured to augment image data obtained by left and right cameras 2639A and 2639B by providing more information. For example, camera 2639C can be used to supply color information that is not discerned by cameras 2639A and 2639B. In some embodiments, one or more of cameras 2639A to 2639D can include an optional IR cut filter configured to remove IR light from being received at the respective camera sensors.

FIG. 27 illustrates a computing system 2720 and an optional housing 2790, each of which show components that can be included in AR system 2500 and/or VR system 2600. In some embodiments, more or fewer components can be included in optional housing 2790 depending on practical restraints of the respective AR system being described.

In some embodiments, computing system 2720 can include one or more peripherals interfaces 2722A and/or optional housing 2790 can include one or more peripherals interfaces 2722B. Each of computing system 2720 and optional housing 2790 can also include one or more power systems 2742A and 2742B, one or more controllers 2746 (including one or more haptic controllers 2747), one or more processors 2748A and 2748B (as defined above, including any of the examples provided), and memory 2750A and 2750B, which can all be in electronic communication with each other. For example, the one or more processors 2748A and 2748B can be configured to execute instructions stored in memory 2750A and 2750B, which can cause a controller of one or more of controllers 2746 to cause operations to be performed at one or more peripheral devices connected to peripherals interface 2722A and/or 2722B. In some embodiments, each operation described can be powered by electrical power provided by power system 2742A and/or 2742B.

In some embodiments, peripherals interface 2722A can include one or more devices configured to be part of computing system 2720, some of which have been defined above and/or described with respect to the wrist-wearable devices shown in FIGS. 23 and 24. For example, peripherals interface 2722A can include one or more sensors 2723A. Some example sensors 2723A include one or more coupling sensors 2724, one or more acoustic sensors 2725, one or more imaging sensors 2726, one or more EMG sensors 2727, one or more capacitive sensors 2728, one or more IMU sensors 2729, and/or any other types of sensors explained above or described with respect to any other embodiments discussed herein.

In some embodiments, peripherals interfaces 2722A and 2722B can include one or more additional peripheral devices, including one or more NFC devices 2730, one or more GPS devices 2731, one or more LTE devices 2732, one or more Wi-Fi and/or Bluetooth devices 2733, one or more buttons 2734 (e.g., including buttons that are slidable or otherwise adjustable), one or more displays 2735A and 2735B, one or more speakers 2736A and 2736B, one or more microphones 2737, one or more cameras 2738A and 2738B (e.g., including the left camera 2739A and/or a right camera 2739B), one or more haptic devices 2740, and/or any other types of peripheral devices defined above or described with respect to any other embodiments discussed herein.

AR systems can include a variety of types of visual feedback mechanisms (e.g., presentation devices). For example, display devices in AR system 2500 and/or VR system 2600 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 2735A and 2735B can be coupled to each of the lenses 2506-1 and 2506-2 of AR system 2500. Displays 2735A and 2735B may be coupled to each of lenses 2506-1 and 2506-2, which can act together or independently to present an image or series of images to a user. In some embodiments, AR system 2500 includes a single display 2735A or 2735B (e.g., a near-eye display) or more than two displays 2735A and 2735B. In some embodiments, a first set of one or more displays 2735A and 2735B can be used to present an augmented-reality environment, and a second set of one or more display devices 2735A and 2735B can be used to present a virtual-reality environment. In some embodiments, one or more waveguides are used in conjunction with presenting artificial-reality content to the user of AR system 2500 (e.g., as a means of delivering light from one or more displays 2735A and 2735B to the user's eyes). In some embodiments, one or more waveguides are fully or partially integrated into the eyewear device 2502. Additionally, or alternatively to display screens, some artificial-reality systems include one or more projection systems. For example, display devices in AR system 2500 and/or VR system 2600 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 2735A and 2735B.

Computing system 2720 and/or optional housing 2790 of AR system 2500 or VR system 2600 can include some or all of the components of a power system 2742A and 2742B. Power systems 2742A and 2742B can include one or more charger inputs 2743, one or more PMICs 2744, and/or one or more batteries 2745A and 2744B.

Memory 2750A and 2750B may include instructions and data, some or all of which may be stored as non-transitory computer-readable storage media within the memories 2750A and 2750B. For example, memory 2750A and 2750B can include one or more operating systems 2751, one or more applications 2752, one or more communication interface applications 2753A and 2753B, one or more graphics applications 2754A and 2754B, one or more AR processing applications 2755A and 2755B, and/or any other types of data defined above or described with respect to any other embodiments discussed herein.

Memory 2750A and 2750B also include data 2760A and 2760B, which can be used in conjunction with one or more of the applications discussed above. Data 2760A and 2760B can include profile data 2761, sensor data 2762A and 2762B, media content data 2763A, AR application data 2764A and 2764B, and/or any other types of data defined above or described with respect to any other embodiments discussed herein.

In some embodiments, controller 2746 of eyewear device 2502 may process information generated by sensors 2723A and/or 2723B on eyewear device 2502 and/or another electronic device within AR system 2500. For example, controller 2746 can process information from acoustic sensors 2525-1 and 2525-2. For each detected sound, controller 2746 can perform a direction of arrival (DOA) estimation to estimate a direction from which the detected sound arrived at eyewear device 2502 of AR system 2500. As one or more of acoustic sensors 2725 (e.g., the acoustic sensors 2525-1, 2525-2) detects sounds, controller 2746 can populate an audio data set with the information (e.g., represented as sensor data 2762A and 2762B).

In some embodiments, a physical electronic connector can convey information between eyewear device 2502 and another electronic device and/or between one or more processors 2548, 2748A, 2748B of AR system 2500 or VR system 2600 and controller 2746. The information can be in the form of optical data, electrical data, wireless data, or any other transmittable data form. Moving the processing of information generated by eyewear device 2502 to an intermediary processing device can reduce weight and heat in the eyewear device, making it more comfortable and safer for a user. In some embodiments, an optional wearable accessory device (e.g., an electronic neckband) is coupled to eyewear device 2502 via one or more connectors. The connectors can be wired or wireless connectors and can include electrical and/or non-electrical (e.g., structural) components. In some embodiments, eyewear device 2502 and the wearable accessory device can operate independently without any wired or wireless connection between them.

In some situations, pairing external devices, such as an intermediary processing device (e.g., HIPD 1906, 2006, 2106) with eyewear device 2502 (e.g., as part of AR system 2500) enables eyewear device 2502 to achieve a similar form factor of a pair of glasses while still providing sufficient battery and computation power for expanded capabilities. Some, or all, of the battery power, computational resources, and/or additional features of AR system 2500 can be provided by a paired device or shared between a paired device and eyewear device 2502, thus reducing the weight, heat profile, and form factor of eyewear device 2502 overall while allowing eyewear device 2502 to retain its desired functionality. For example, the wearable accessory device can allow components that would otherwise be included on eyewear device 2502 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 2502 standing alone. Because weight carried in the wearable accessory device can be less invasive to a user than weight carried in the eyewear device 2502, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 2500 and/or VR system 2600 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 26A and 26B show VR system 2600 having cameras 2639A to 2639D, which can be used to provide depth information for creating a voxel field and a two-dimensional mesh to provide object information to the user to avoid collisions.

In some embodiments, AR system 2500 and/or VR system 2600 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 2500 and/or VR system 2600, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to a lens that comprises or includes polycarbonate include embodiments where a lens consists essentially of polycarbonate and embodiments where a lens consists of polycarbonate.

What is claimed is:

1. A projection system comprising:
at least one source array having a plurality (m×n) of individually addressable sources in which each source has a size Yₛ and an emission cone numerical aperture (NAₛ);
at least one concentrator array made of a plurality (m×n) of individual concentrators overlying the source array in which each individual concentrator comprises:
an input facet size Yᵢₙ; and
an output facet size Yₒᵤₜ, wherein the concentrators are configured to condition output light from the source array from NAₛ to a smaller numerical aperture NAₒᵤₜ;
a non-emissive display comprising an array of k×l individually addressable pixels, wherein k and l are each at least 500 and a pixel size is selected by desired far-field angular resolution and volume constraints of the projector system, the non-emissive display having an active area XY;
an illumination optical system configured to image the output facet of the individual concentrators onto the non-emissive display with a magnification factor M; and
a projection lens adapted to collimate light from the non-emissive display, the projection lens having a focal length f and a pupil diameter D.

2. The projection system of claim 1, wherein Yᵢₙ is equal to Yₛ+/−10%.

3. The projection system of claim 1, wherein NAₒᵤₜ=NAₛ(Yᵢₙ/Yₒᵤₜ), and an area of the sum of the m×n individual concentrators output facets is LₓL_{y}, where Lₓ=mYₒᵤₜ and L_{y}=nYₒᵤₜ.

4. The projection system of claim 1, wherein M [Lₓ L_{y}]=[X Y]+/−10%.

5. The projection system of claim 1, wherein a collection numerical aperture NA_{c} of the projection lens is equal to approximately D/2/f, wherein NA_{c}=NAₛ(Yᵢₙ/Yₒᵤₜ)/M.

6. The projection system of claim 1, wherein each individual source of the array comprises at least three sub-sources emitting different colors.

7. The projection system of claim 6, wherein the sub-sources comprise mini-LEDs or uLEDs having an emission numerical aperture NAₛ of at least approximately 0.8.

8. The projection system of claim 1, wherein the at least one concentrator array is located on a first side of the non-emissive display and the projection lens is located on a second side of the non-emissive display opposite to the first side.

9. The projection system of claim 1, wherein the projection lens comprises a triple pass polarization beam splitter and reflective optics.

10. The projection system of claim 1, wherein the illumination optical system comprises at least one polarization beam splitter and one reflecting curved mirror.

11. The projection system of claim 1, wherein a focus condition of the illumination optical system is configured to defocus and smooth edges of the output light incident on the non-emissive display.

12. The projection system of claim 1, wherein each individual concentrator comprises a taper segment having a taper length of at least 5× the input facet size Yᵢₙ.

13. The projection system of claim 1, comprising three separate source arrays each having a corresponding concentrator array.

14. A system comprising:
a micro-LED array having a plurality of individually addressable diodes;
a concentrator array overlying an output of the micro-LED array and configured to decrease a numerical aperture of light emitted by the micro-LED array; and
a non-emissive display panel arranged to receive light from the concentrator array.

15. The system of claim 14, wherein the concentrator array comprises a plurality of tapered optical elements.

16. The system of claim 14, wherein the concentrator array comprises a plurality of compound parabolic collectors.

17. The system of claim 14, wherein the non-emissive display panel comprises a liquid crystal panel or a digital micromirror device (DMD).

18. The system of claim 14, further comprising a polarization beam splitter between an output of the concentrator array and an input of the non-emissive display.

19. The system of claim 18, further comprising a Fresnel lens located proximate to an output of the polarization beam splitter.

20. A projection system comprising:
an illumination source having a plurality of individually addressable illumination components;
a concentrator array overlying an output of the illumination source and configured to decrease a numerical aperture of light emitted by the illumination components; and
a non-emissive display panel arranged to receive light from the concentrator array.
